(19) United States
(12) Patent Application Publication
(10) Pub. No.: US 2007/0212587 A1
(43) Pub. Date: Sep. 13, 2007

(54) Apparatus for and method of forming seals in an electrochemical cell assembly

(76) Inventors: Nick Fragiadakis, Toronto (CA); Raymond Candido, Toronto (CA); H. Samuel Frost, Toronto (CA)

Correspondence Address: BERESKIN AND PARR, 40 KING STREET WEST, BOX 401, TORONTO, ON, M5H 3Y2, CA

(21) Appl. No.: 10/536,096

(22) Filed: Apr. 1, 2005

(51) Int. Cl. H01M 2/08; H01M 8/24; B05D 5/12

(52) U.S. Cl. 429/35; 429/36; 429/38; 427/115; 29/623.2

(57) ABSTRACT

A sealing and repair technique is provided for forming complex and multiple seal configurations for fuel cells and other electrochemical cells. To provide a seal, for sealing chambers for oxidant, fuel and/or coolant, a groove network is provided extending through the various elements of the fuel cell assembly. A source of seal material is then connected to an external filling port and injected into the groove network, and the seal material is then cured to form the seal. There is thus formed a “seal in place”, that is robust and can accommodate variations in tolerances and dimensions, and that can be bonded, where possible, to individual elements of the fuel cell assembly. To repair part of an electrochemical cell stack, some elements are removed and either repaired or replaced. The cell assembly is then put together again and a bore is provided for injection of fresh seal material. This bore can either have been formed in the original assembly or is formed by mechanical removal of part of the original seal material

### FIELD OF THE INVENTION

This invention relates to electrochemical cells, and this invention more particularly is concerned with an apparatus and a method of forming seals between different elements of a conventional fuel cell or other electrochemical cell stack assembly, to prevent leakage of gases and liquids required for operation of the individual cells. The invention also relates to a method of forming seals with a novel seal material.

### BACKGROUND OF THE INVENTION

There are various known types of fuel cells. One form of fuel cell that is currently believed to be practical for usage in many applications is a fuel cell employing a proton exchange membrane (PEM). A PEM fuel cell enables a simple, compact fuel cell to be designed, which is robust, which can be operated at temperatures not too different from ambient temperatures and which does not have complex requirements with respect to fuel, oxidant and coolant supplies.

Conventional fuel cells generate relatively low voltages. In order to provide a useable amount of power, fuel cells are commonly configured into fuel cell stacks, which typically may have 10, 20, 30 or even 100's of fuel cells in a single stack. While this does provide a single unit capable of generating useful amounts of power at usable voltages, the design can be quite complex and can include numerous elements, all of which must be carefully assembled.

For example, a conventional PEM fuel cell requires two flow field plates, an anode flow field plate and a cathode flow field plate. A membrane electrode assembly (MEA), including the actual proton exchange membrane is provided between the two plates. Additionally, a gas diffusion media (GDM) is provided, sandwiched between each flow field plate and the proton exchange membrane. The gas diffusion media enables diffusion of the appropriate gas, either the fuel or oxidant, to the surface of the PEM, and at the same time provides for conduction of electricity between the associated flow field plate and the PEM.

This basic cell structure itself requires two seals, each seal being provided between one of the flow field plates and the PEM. Moreover, these seals have to be of a relatively complex configuration. In particular, as detailed below, the flow field plates, for use in the fuel cell stack, have to provide a number of functions and a complex sealing arrangement is required.

For a fuel cell stack, the flow field plates typically provide apertures or openings at either end, so that a stack of flow field plates then define elongate channels extending perpendicularly to the flow field plates. As a fuel cell requires flows of a fuel, an oxidant and a coolant, this typically requires three pairs of ports or six ports in total. This is because it is necessary for the fuel and the oxidant to flow through each fuel cell. A continuous flow through ensures that, while most of the fuel or oxidant as the case may be is consumed, any contaminants are continually flushed through the fuel cell.

The foregoing assumes that the fuel cell would be a compact type of configuration provided with water or the like as a coolant. There are known stack configurations, which use air as a coolant, either relying on natural convection or by forced convection. Such cell stacks typically provide open channels through the stacks for the coolant, and the sealing requirements are lessened. Commonly, it is then only necessary to provide sealed supply channels for the oxidant and the fuel.

Consequently, each flow field plate typically has three apertures at each end, each aperture representing either an inlet or outlet for one of fuel, oxidant and coolant. In a completed fuel cell stack, these apertures align, to form distribution channels extending through the entire fuel cell stack. It will thus be appreciated that the sealing requirements are complex and difficult to meet. However, it is possible to have multiple inlets and outlets to the fuel cell for each fluid depending on the stack/cell design. For example, some fuel cells have 2 inlet ports for each of the anode, cathode and coolant, 2 outlet ports for the coolant and only 1 outlet port for each of the cathode and anode. However, any combination can be envisioned.

For the coolant, this commonly flows across the back of each fuel cell, so as to flow between adjacent, individual fuel cells. This is not essential however and, as a result, many fuel cell stack designs have cooling channels only at every 2nd, 3rd or 4th (etc.) plate. This allows for a more compact stack (thinner plates) but may provide less than satisfactory cooling. This configuration provides the requirement for another seal, namely a seal between each adjacent pair of individual fuel cells. Thus, in a completed fuel cell stack, each individual fuel cell will require two seals just to seal the membrane electrode assembly to the two flow field plates. A fuel cell stack with 30 individual fuel cells will require 60 seals just for this purpose. Additionally, as noted, a seal is required between each adjacent pair of fuel cells and end seals to current collectors. For a 30 cell stack, this requires an additional 31 seals. Thus, a 30 cell stack would require a total of 91 seals (excluding seals for the bus bars, current collectors and endplates), and each of these would be of a complex and elaborate construction. With the additional gaskets required for the bus bars, insulator plates and endplates the number reaches 100 seals, of various configurations, in a single 30 cell stack.

Commonly the seals are formed by providing channels or grooves in the flow field plates, and then providing prefabricated gaskets in these channels or grooves to effect a seal. In known manner, the gaskets (and/or seal materials) are specifically polymerized and formulated to resist degradation from contact with the various materials of construction in the fuel cell, various gasses and coolants which can be aqueous, organic and inorganic fluids used for heat transfer. However, this means that the assembly technique for a fuel cell stack is complex, time consuming and offers many opportunities for mistakes to be made. Reference to a resilient seal here refers typically to a floppy gasket seal molded separately from the individual elements of the fuel cells by known methods such as injection, transfer or compression molding of elastomers. By known methods, such as insert injection molding, a resilient seal can be fabricated on a plate, and clearly assembly of the unit can then be simpler, but forming such a seal can be difficult and expensive due to inherent processing variables such as mold wear, tolerances in fabricated plates and material changes. In addition custom made tooling is required for each seal and plate design.

An additional consideration is that formation or manufacture of such seals or gaskets is complex. There are typically two known techniques for manufacturing them.

For the first technique, the individual gasket is formed by molding in a suitable mold. This is relatively complex and expensive. For each fuel cell configuration, it requires the design and manufacture of a mold corresponding exactly to the shape of the associated grooves in the flow field plates. This does have the advantage that the designer has complete freedom in choosing the cross-section of each gasket or seal, and in particular, it does not have to have a uniform thickness.

A second, alternative technique is to cut each gasket from a solid sheet of material. This has the advantage that a cheaper and simpler technique can be used. It is simply necessary to define the shape of the gasket, in a plan view, and to prepare a cutting tool to that configuration. The gasket is then cut from a sheet of the appropriate material of appropriate thickness. This does have the disadvantage that, necessarily, one can only form gaskets having a uniform thickness. Additionally, it leads to considerable wastage of material. For each gasket, a portion of material corresponding to the area of a flow field plate must be used, yet the surface area of the seal itself is only a small fraction of the area of the flow field plate.

A fuel cell stack, after assembly, is commonly clamped to secure the elements and ensure that adequate compression is applied to the seals and active area of the fuel cell stack. This method ensures that the contact resistance is minimized and the electrical resistance of the cells are at a minimum. To this end, a fuel cell stack typically has two substantial end plates, which are configured to be sufficiently rigid so that their deflection under pressure is within acceptable tolerances. The fuel cell also typically has current bus bars to collect and concentrate the current from the fuel cell to a small pick up point and the current is then transferred to the load via conductors. Insulation plates may also be used to isolate, both thermally and electrically, the current bus bars and endplates from each other. A plurality of elongated rods, bolts and the like are then provided between the pairs of plates, so that the fuel cell stack can be clamped together between the plates, by the tension rods. Rivets, straps, piano wire, metal plates and other mechanisms can also be used to clamp the stack together. To assemble the stack, the rods are provided extending through one of the endplates. An insulator plate and then a bus bar (including seals) are placed on top of the endplate, and the individual elements of the fuel cell are then built up within the space defined by the rods or defined by some other positioning tool. This typically requires, for each fuel cell, the following steps:
(a) placing a first seal to separate the fuel cell from the preceding fuel cell;
(b) locating a first flow field plate on the first seal;
(c) locating a second seal on the first flow field plate;
(d) placing a GDM within thesecond seal on the first flow field plate;
(e) locating an MEA on the second seal;
(f) placing an additional GDM on top of the MEA;
(g) preparing a second flow field plate with a seal and placing this on top of the MEA, while ensuring the seal of the second plate falls around the second GDM;
(h) this second or upper flow field plate then showing a groove for receiving a seal, as in step (a).

This process needs to be repeated until the last fuel cell is formed and it is then topped off with a bus bar, insulator plate and the final end plate.

It will be appreciated that each seal has to be carefully placed, and the installer has to ensure that each seal is fully and properly engaged in its sealing groove. It is very easy for an installer to overlook the fact that a small portion of a seal may not be properly located. The seal between adjacent pairs of fuel cells, for the coolant area, may have a groove provided in the facing surfaces of the two flow field plates. Necessarily, an installer can only locate the seal in one of these grooves, and must rely on feel or the like to ensure that the seal properly engages in the groove of the other plate during assembly. It is practically impossible to visually inspect the seal to ensure that it is properly seated in both grooves.

As mentioned, it is possible to mold seals directly onto the individual cells. While this does offer an advantage during assembly when compared to floppy seals, such as better tolerances and improved part allocation, it still has many disadvantages over the technique of the present invention namely, alignment problems with the MEA, multiple seals and molds required to make the seals. In addition, more steps are required for a completed product than the methods proposed by the present invention.

Thus, it will be appreciated that assembling a conventional fuel cell stack is difficult, time consuming, and can often lead to sealing failures. After a complete stack is assembled, it is tested, but this itself can be a difficult and complex procedure. Even if a leak is detected, this may initially present itself simply as an inability of the stack to maintain pressure of a particular fluid, and it may be extremely difficult to locate exactly where the leak is occurring, particularly where the leak is internal. Even so, the only way to repair the stack is to disassemble it entirely and to replace the faulty seal. This will result in disruption of all the other seals, so that the entire stack and all the different seals then have to be reassembled, again presenting the possibility of misalignment and failure of any one seal.

A further problem with conventional techniques is that the clamping pressure applied to the entire stack is, in fact, intended to serve two quite different and distinct functions. These are providing a sufficient pressure to ensure that the seals function as intended, and to provide a desired pressure or compression to the gas diffusion media, sandwiched between the MEA itself and the individual flow field plates. If insufficient pressure is applied to the GDM, then poor electrical contact is made; on the other hand, if the GDM is over compressed, flow of gas can be compromised. Unfortunately, in many conventional designs, it is only possible to apply a known, total pressure to the overall fuel cell stack. There is no way of knowing how this pressure is divided between the pressure applied to the seals and the pressure applied to the GDM. In conventional designs, this split in the applied pressure depends entirely upon the design of the individual elements in the fuel cell stack and maintenance of appropriate tolerances. For example, the GDM commonly lie in center portions of flow field plates, and if the depth of each center portion varies outside acceptable tolerances, then this will result in incorrect pressure being applied to the GDM. This depth may depend to what extent a gasket is compressed also, affecting the sealing properties, durability and lifetime of the seal.

For all these reasons, manufacture and assembly of conventional fuel cells is time consuming and expensive. More particularly, present assembly techniques are entirely unsuited to large-scale production of fuel cells on a production line basis.

### SUMMARY OF THE INVENTION

In accordance with earlier application Ser. No. 09/854,362, there was provided a fuel cell assembly, and an associated method, comprising:
a plurality of separate elements;
at least one groove network extended throughout the fuel cell assembly and including at least one filling port for the at least one groove network; and
a seal within each groove network that has been formed in place after assembly of said separate elements, wherein the seal provides a seal between at least two of said separate elements to define a chamber for a fluid for operation of the fuel cell.

The method of that invention provides a number of advantages over conventional constructions employing separate gaskets. Firstly, the invention allows efficient and accurate clamping and position of the membrane active area of each fuel cell. In contrast, in conventional techniques, all the elements of a multi-cell stack are assembled with the elements slightly spaced apart, and it is only the final clamping that draws all the elements together in their final, clamped position; this can make it difficult to ensure accurate alignment of different elements in the stack. The tolerance requirements for grooves for the seal can be relaxed considerably, since it is no longer necessary for them to correspond to a chosen gasket dimension. The liquid material injected can compensate for a wide range of variations in groove dimensions. Combining these attributes of the invention allows the utilization of significantly thinner plate constructions. The current trend in fuel cell design calls for thinner and thinner flow plates, with the intention of reducing the overall dimensions of a fuel cell stack of a given power. Using the sealing technique of the present invention, the grooves can have a relatively thin bottom wall, i.e. the wall opposite the open side of the groove. This is because when the stack is first assembled, there is no pressure in the groove, and, in an assembled condition, the configuration can be such as to provide support for any thin-walled sections. Only after assembly is the seal material injected and cured.

Use of a liquid sealant that is cured to form an elastomeric material allows the use of materials designed to chemically bond to various elements of the fuel cell stack, thereby ensuring and/or enhancing the seal performance. This should also increase the overall durability of the fuel cell stack. Also, it is anticipated that some fuel cell stack designs will use aggressive coolants, e.g. glycols, and with the present invention it is a simple matter to select a seal material compatible with the coolant and other fluids present.

However, a potential disadvantage of that earlier invention, outlined above, is that any electrochemical cell stack, once assembled, can not readily be dismantled, e.g. for repair. While convention arrangements, using separate gaskets and the like, can be difficult and labor-intensive to assemble, they do enable a stack, at any time, to be disassembled and damaged components to be placed, and the stack subsequently reassembled by clamping together, etc.

The present invention is intended to provide a technique that enables an electrochemical cell assembly or stack, constructed in accordance with that earlier application Ser. No. 09/854,362, to be at least partially disassembled, e.g. for repair and replacement, and then reassembled. More specifically, the present invention provides a number of techniques for providing fluid communication to grooves within a reassembled electrochemical cell stack, so that a curable seal material can be injected and caused to cure, to reform seals within the stack or assembly.

As such, the present invention has applicability to any electrochemical cell assembly having seals intended to be permanent and not readily permitting disassembly of the separate components. For example, in some cases, conventional separately molded gaskets may be bonded to other components with adhesive and the like, so as not to permit a stack to be readily disassembled. Such stacks could be reassembled with grooves connected to a filling port, to enable at least part of the stack to be resealed with a curable seal material, in accordance with the present invention.

The present invention requires the provision of grooves so that the seal material can be supplied to facing surfaces that need to be sealed together. In this respect, it is common to provide facing groove halves (which may not be of identical or similar cross-section) to form each groove. However, it will be understood that, for some purposes, it may be preferable to provide the entirety of the groove in one element, and to provide a facing element with a flat surface. In many cases, the provision of a flat sealing surface on one element is a simple way to accommodate any misalignment of that element.

In accordance with the first aspect of the present invention, there is provided an electrochemical cell assembly comprising:
(a) A plurality of separate elements, at least some of the elements including grooves for seals;
(b) a plurality of seals in the grooves between the plurality of separate elements, sealing the elements to control fluid flow;
wherein the elements and the seals are bonded together such that separation of two for more elements will result in damage to one or more of the seals and separate elements; and
wherein the electrochemical cell assembly includes, for each of at least some of the separate elements, a resealing portion permitting a bore to be formed therethrough to provide fluid communication to at least one of the grooves, whereby, in use, the electrochemical cell assembly can be at least partially disassembled, any damaged elements can be replaced, at least one bore can be formed through selected ones of said resealing portions connecting with said at least one of the grooves to form a groove network, whereby the electrochemical cell assembly can be reassembled and curable seal material can be injected into the groove network and cured to reseal the electrochemical cell assembly.

Another aspect of the present invention provides an electrochemical cell assembly comprising:
a plurality of separate elements;
at least one groove network extending through the electrochemical cell assembly, and at least partially between the plurality of separate elements including at least one filling port for the at least one groove network;
a seal within the at least one groove network, that seal having been formed in place from a cured liquid seal material after assembly of said separate elements, wherein the seal provides a barrier between at least two of said separate elements to define a chamber for a fluid for operation of the electrochemical cell assembly; and
for each of at least some of the plurality of separate elements of the electrochemical cell assembly, a resealing portion permitting at least one bore to be formed therethrough to provide fluid communication to at least one of the groove networks, whereby in use, the electrochemical cell assembly can be at least partially disassembled, and subsequently reassembled, with said at least one bore enabling a liquid seal material to be injected after reassembly for resealing the electrochemical cell assembly.

A further aspect of the present invention provides a method of forming a seal in an electrochemical cell assembly comprising a plurality of separate elements, the method comprising:
(c) assembling the separate elements of the fuel cell together;
(d) providing at least one groove network extending through the separate elements and a filling port open to the exterior and in communication with the at least one groove network;
(a) connecting a source of liquid seal material to the filling port and injecting the seal material into the at least one groove network to fill the at least one groove network and simultaneously venting gas therefrom; and
(b) forming a bore in the seal material extending through at least some of the plurality of separate elements, and curing the seal material, to form a seal in the at least one groove network.

As a variant to the method aspect of the present invention, there is provided a method of forming a seal, the method comprising:
(a) assembling the separate elements of the fuel cell together;
(b) providing at least one main manifold extending through the plurality of separate elements and including at least one open end open to the exterior of the electrochemical cell assembly.
(c) providing at least one groove network extending through the separate elements and a filling port open to the exterior and in communication with the at least one main manifold and with the at least one groove network;
(d) connecting a source of liquid seal material to the filling port and injecting the seal material into the at least one groove network to fill the at least one groove network and simultaneously venting gas therefrom;
   whereby, the provision of said at least one open end enables a bore to be formed subsequently through at least some elements of the electrochemical cell assembly, for reassembly thereof.

Another aspect of the method portion of the present invention provides a method of disassembling and reassembling electrochemical cells comprising:
(e) a plurality of separate elements, at lease some of the separate elements including grooves for seals;
(f) plurality of seals in the grooves between the separate elements; the method comprising the steps of:

(1) separating the electrochemical cell assembly into at least two parts, each including at least one of said plurality of separate elements;

(2) cleaning and removing any existing seal material in one or more of the grooves on facing surfaces of said at least two parts of the electrochemical cell assembly;

(3) providing at least one bore extending through the electrochemical cell assembly, and communicating with each empty groove;

(4) reassembling the said at least two parts together; and

(5) injecting fresh seal material through the bore to fill each empty groove, and curing the fresh seal material to reform the seal between said at least two parts of the electrochemical cell assembly.

The invention also provides an apparatus for providing a seal material to an electrochemical cell assembly for sealing various components of the electrochemical cell, the apparatus comprising:
(a) a main body;
(b) an inlet disposed near one end of the main body for receiving the seal material; and
(c) an outlet disposed near the other end of the main body for providing the seal material to at least one portion of the electrochemical cell;
   wherein the main body generally has an appropriate shape for leaving a bore in the electrochemical cell after the seal material has been delivered to the electrochemical cell.

### BRIEF DESCRIPTION OF THE DRAWING FIGURES

For a better understanding of the present invention and to show more clearly how it may be carried into effect, reference will now be made, by way of example, to the accompanying drawings which show, by way of example, a preferred embodiment of the present invention and in which:

FIG. 1a shows, schematically, a sectional view through part of a fuel cell stack;

FIG. 1b-1e show variant seal arrangements for use in the embodiment of FIG. 1, and other embodiments;

FIG. 2 shows, schematically, a sectional view through part of a fuel cell stack in accordance with a second embodiment;

FIG. 3 shows a sectional view of an assembly device, for assembling a fuel cell stack;

FIG. 4 shows an isometric view of a fuel cell stack;

FIG. 5 shows an isometric exploded view of the fuel cell stack of FIG. 4, to show individual components thereof;

FIGS. 6a and 6b show, respectively, a twenty cell and a one hundred cell fuel cell stack;

FIGS. 7 and 8 show, respectively, front and rear views of an anode bipolar flow field plate of the fuel cell stack of FIGS. 5 and 6;

FIGS. 9 and 10 show, respectively, front and rear views of a cathode bipolar flow field plate of the fuel cell stack of FIGS. 5 and 6;

FIG. 11 shows a rear view of an anode end plate;

FIG. 12 shows a view, on a larger scale, of a detail 12 of FIG. 11;

FIG. 13 shows a cross-sectional view along the lines 13 of FIG. 12;

FIG. 14 shows a rear view of a cathode end plate;

FIG. 15 shows a view, on a larger scale, of a detail 15 of FIG. 14;

FIGS. 16a and 16b show schematically different configurations for pumping elastomeric seal material into a fuel cell stack;

FIG. 17 shows a variant of one end of the front face of the anode bipolar flow field plate, the other end corresponding;

FIG. 18 shows a variant of one end of the rear face of the anode bipolar flow field plate, the other end corresponding;

FIG. 19 shows a variant of one end of the front face of the cathode bipolar flow field plate, the other end corresponding;

FIG. 20 shows a variant of one end of the rear face of the cathode bipolar flow field plate, the other end corresponding;

FIG. 21 is a perspective, cut-away view showing details at the end of one of the plates, showing the variant plates;

FIGS. 22a and 22b show schematic side views of a fuel cell stack with an apparatus for injecting a seal material, and a fuel cell stack with an apparatus for injecting a seal material for repair purposes, respectively, in accordance with the present invention;

FIGS. 23a-23g show schematic cross sections through part of a fuel cell stack, with FIGS. 23a-23c indicating an initial filling of the stack with a seal material and curing, and FIGS. 23d-23g showing a sequence for repairing seals in some of the cells of the stack;

FIGS. 24a and 24b show a schematic representation of one device for controlling injection of a seal material into fuel cell stack in accordance with the present invention;

FIGS. 25a and 25b show a variant of the device of FIGS. 24a and 24b;

FIG. 26 shows schematically a further embodiment for controlling injection of seal material to selected cells within a fuel cell stack in accordance with the present invention;

FIGS. 27a and 27b show a further embodiment for injecting a seal material into a fuel cell stack in accordance with the present invention; and

FIG. 28 shows a further embodiment for controlled injection of a seal material in accordance with the present invention.

### DESCRIPTION OF THE PREFERRED EMBODIMENTS

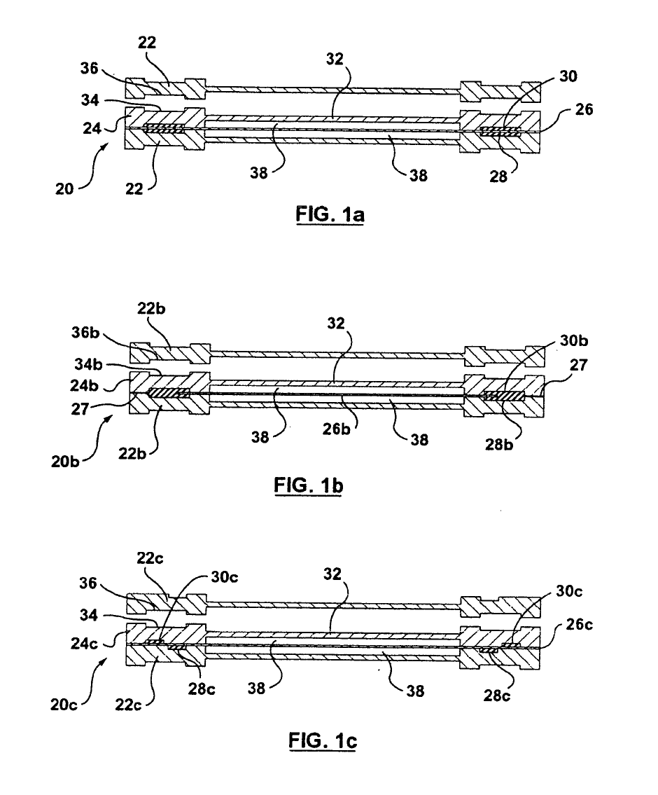

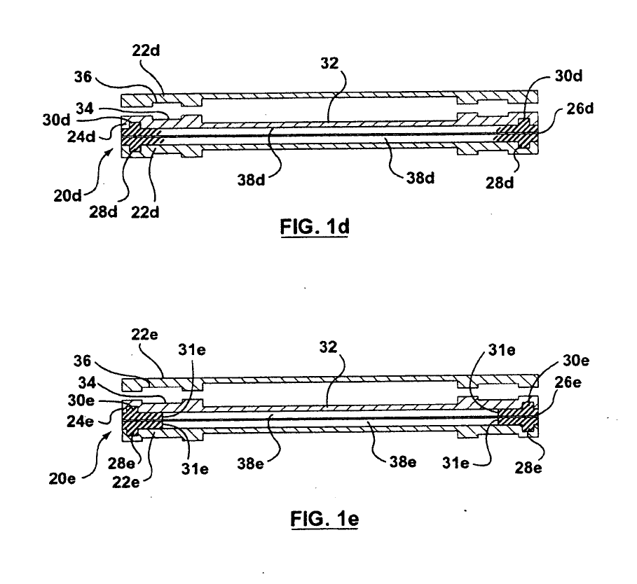

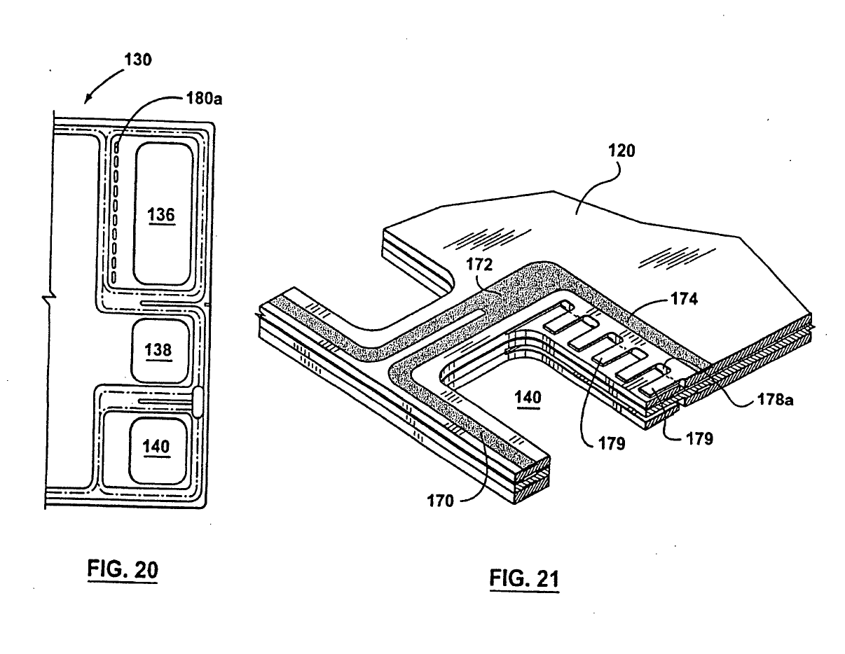

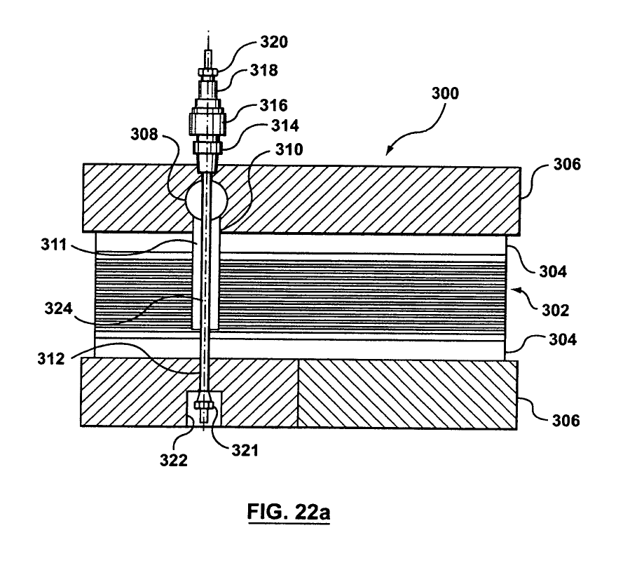

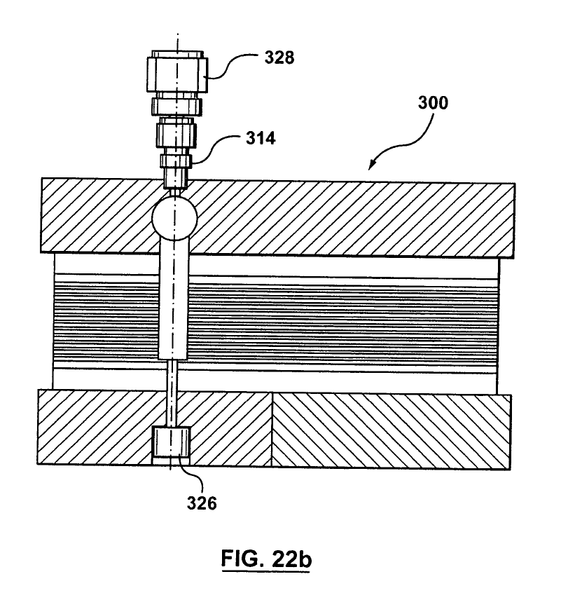

FIGS. 1-21 show the invention as disclosed in earlier application Ser. No. 09/854,362. FIGS. 22-28 disclose details of the present invention. The contents of application Ser. No. 09/854,362 are hereby incorporated by reference.

Earlier application Ser. No. 09/854,362 generally describes a technique in which seals are formed in a complex structure requiring numerous seals, e.g. an electrochemical cell stack that may require hundreds of separate seals, by forming a groove network, injecting a curable seal material, and then curing the seal material. This overcomes problems of alignment tolerances etc, encountered in assembling a conventional stack.

However, this technique results in a permanently assembled stack that provides no opportunity for disassembly or repair. For example, if a membrane in one cell of a fuel cell stack fails, this will result in unacceptable mixing of the fuel and oxidant gases. In many cases, the remainder of the cell stack will be in good condition and still meet set specifications.

Accordingly, the present invention provides a technique to enable disassembly and reassembly of such electrochemical cell stacks. Primarily, such a technique is intended to enable damaged components to be repaired or replaced.

In a large, complex stack, it only requires the damaged parts to be disassembled. Cells in good working order are not affected in any way.

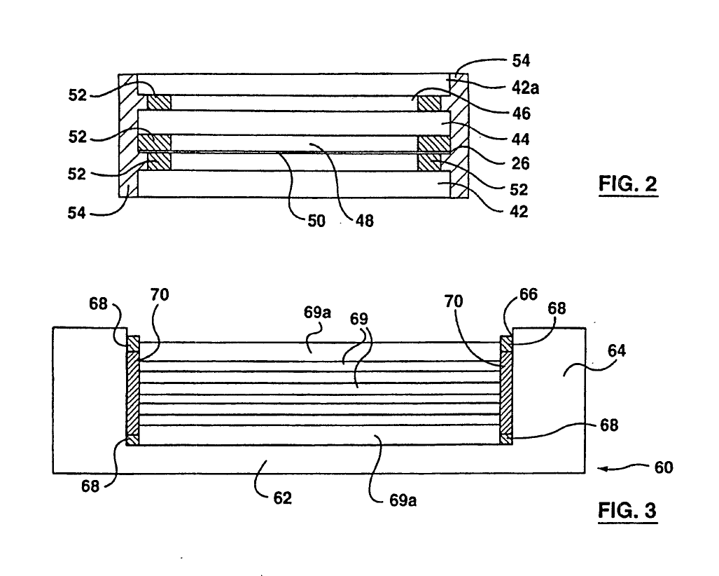

The first embodiment of the earlier invention is shown in FIG. 1a and indicated generally by the reference 20. For simplicity, this Figure shows just part of a fuel cell stack, as does FIG. 2. It will be understood that the other fuel cells in the stack correspond, and that the fuel cell stack would include conventional end elements, clamping elements and the like. In general, FIGS. 1a-3 are intended to indicate the essential elements of the individual embodiments of the invention, and it will be understood by someone skilled in this art that the fuel cell stacks would be otherwise conventional. Also in FIGS. 1a-e and 2, the proton exchange membrane is shown, for clarity, with exaggerated thickness, and as is known, it has a small thickness. In FIGS. 1a-e, the grooves for the seal material are shown schematically, and it is expected that the grooves will usually have a depth and width that are similar, i.e. a generally square cross-section. Note also that the bottom of the grooves can have any desired profile.

The first embodiment 20 shows a fuel cell including an anode bipolar plate 22 and a cathode bipolar plate 24. In known manner, sandwiched between the bipolar plates 22, 24 is a membrane electrode assembly (MEA) 26. In order to seal the MEA, each of the bipolar plates 22, 24 is provided with a respective groove 28, 30. This is a departure from conventional practice, as it is common to provide the flow plates with channels for gases but with no recess for gas diffusion media (GDM) or the like. Commonly, the thickness of seals projecting above the flow plates provides sufficient space to accommodate the GDM. Here, the flow plates are intended to directly abut one another, thereby giving much better control on the space provided for a complete MEA 26 and hence the pressure applied to the GDM. This should ensure better and more uniform performance from the GDM.

As is conventional, the MEA is considered to comprise a total of three layers, namely: a central proton exchange membrane layer (PEM); on both sides of the PEM, a layer of a finely divided catalyst, to promote reaction necessary on either side of the PEM. There are also two layers of gas diffusion media (GDM) located on either side of the PEM abutting the catalyst layers, and usually maintained pressed against the catalyst layers to ensure adequate electrical conductivity, but these two layers of GDM are not considered to be part of the MEA itself.

As shown for the cathode bipolar plate 24, this has a rear face that faces the rear face of another anode bipolar plate 22 of an adjacent fuel cell, to define a coolant channel 32. To seal the cathode bipolar plate 24 and the upper anode bipolar plate 22, again, grooves 34 and 36 are provided.

It will be understood that the anode and cathode bipolar plates 22, 24 define a chamber or cavity for receiving the MEA 26 and for gas distribution media (GDM) on either side of the MEA. The chambers or cavities for the GDM are indicated at 38.

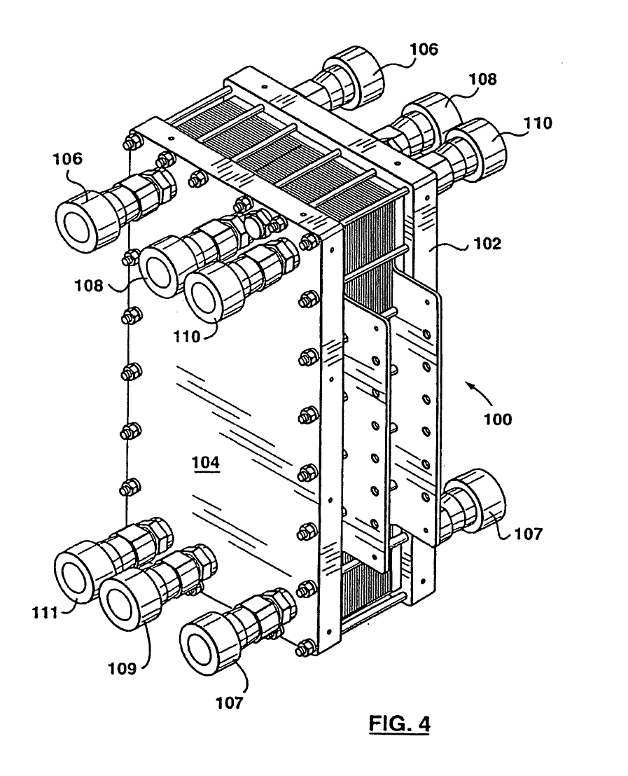

It will be appreciated that FIG. 1a is intended simply to show the basic principle behind the invention, and does not show other elements essential for a complete fuel cell stack. For example, FIG. 1a does not address the issue of providing flows of gases and coolant to the individual fuel cells. The sealing technique of FIG. 1a is incorporated in the embodiment of FIG. 4 and later Figures, and these further aspects of the invention are further explained in relation to those Figures.

FIG. 2 shows an alternative arrangement. Here, the anode and cathode bipolar plates are indicated at 42, 44 and 42a, corresponding to plates 22, and 24 of FIG. 1a. The MEA is again indicated at 26. A coolant cavity is formed at 46, and cavities or chambers 48, 50 are provided for the GDM.

Here, as for FIG. 1a, the plates 42, 44 are designed to provide various cavities or grooves for seals 52 to be formed. Thus, a lowermost seal 52 provides a seal between the MEA 26 and the anode bipolar plate 42. On top of the MEA 26, a further seal 52 provides a seal to the cathode bipolar plate 44. These seals 52 are formed as in FIG. 1a, by first providing a network of grooves or channels across the flow field plate surface.

Now, in accordance with this second embodiment of the present invention, to provide an additional seal and additional security in sealing, a seal-in-place seal 54 is provided around the entire exterior of the fuel cell stack, as indicated. As for FIG. 1a, conventional ports and openings (not shown) would be provided for flow of gases and coolant to the fuel cell stack. To form this seal, the entire stack would be enclosed and ports and vents are provided to enable seal material to be injected to form the outer seal 54 and all the inner seals simultaneously. For this purpose, communication channels and ducts are provided between the grooves for the seals 52 and the exterior of stack where the seal 54 is formed. As before, once the material has been injected, it is cured at room (ambient) temperature or by heating at an elevated temperature. The final seal material on the surface of the stack will serve two purposes, namely to seal the entire stack, and to electrically insulate the fuel cell stack.

In a variant of the FIG. 2 arrangement, rather than provide complete enclosed grooves, the grooves would be open to sides of the fuel cell stack. Then, to form the seals, the sides of the fuel cell stack would be closed off by a mold or the like, somewhat as in FIG. 3 (described below), but without providing any space for a complete external seal around the whole fuel cell stack.

FIG. 3 shows an assembly device indicated generally at 60, for forming a seal, somewhat as for the embodiment of FIG. 2. Here, it is anticipated that a fuel cell stack will first be assembled following known practice, but without inserting any seals. Thus, the various elements of the stack, principally the flow field plates and the MEAs will be sequentially assembled with appropriate end components. To align the components, clamping rods can be used by first attaching these to one end plate, or the components can be assembled in a jig dimensioned to ensure accurate alignment. Either way, with all the components in place the entire assembly is clamped together, commonly by using clamping rods, as mentioned, engaging both end plates. The assembly device 60 has a base 62 and a peripheral wall 64 defining a well 66. Additionally, there are upper and lower projections 68, for engaging the end plates to locate a fuel cell stack in position. Although FIG. 3 shows the projections 68 on just two sides of the fuel cell stack, it will be understood that they are provided on all four sides.

Then, an assembly of elements for a fuel cell stack comprising cathode and anode plates, MEAs, insulators, current bus bars, etc. is positioned within the well 66, with the projections 68 ensuring that there is a space around all of the anode and cathode plates and around at least parts of the end plates. Current collector plates usually have projecting tabs, for connection to cables etc. and accommodation and seals are provided for these. The various layers or plates of the stack are indicated schematically at 69 in FIG. 3, with the end plates indicated at 69a.

Then, in accordance with the present invention, a layer of material is injected around the outside of the stack, as indicated at 70. This then provides a seal somewhat in the manner of FIG. 2. Again, connections would be made to the groove network within the fuel cell stack, so that internal seals are formed simultaneously. In this case, venting would be provided in the end plates. Vent channels would be provided extending through the stack and out of the ends of the stack, and in communication with the groove networks within the stack itself.

To cure the seal material, a curing temperature can usually be selected by selecting suitable components for the seal material. Curing temperatures of, for example, 30° C., 80° C., or higher can be selected. Curing temperature must be compatible with the materials of the fuel cells. It is also anticipated that, for curing at elevated temperatures, heated water could be passed through the stack which should ensure that the entire stack is promptly brought up to the curing temperature, to give a short curing cycle. As noted above, it also anticipated that the invention could use a seal material that cures at ambient temperature, so that no separate heating step is required, or a thermoplastic that sets as cooling. To vent air from the individual grooves during filling with the seal material, vents can be provided.

The invention is described in relation to a single groove network, but it is to be appreciated that multiple groove networks can be provided. For example, in complex designs, it may prove preferable to have individual, separated networks, so that flow of seal material to the individual networks can be controlled. Multiple, separate networks also offer the possibility of using different seal material for different components of a fuel cell assembly. Thus, as noted, a wide variety of different materials can be used in fuel cells. Finding seal materials and a primer that are compatible with the wide range of materials may be difficult. It may prove advantageous to provide separate networks, so that each seal material and primer pair need only be adapted for use with a smaller range of materials.

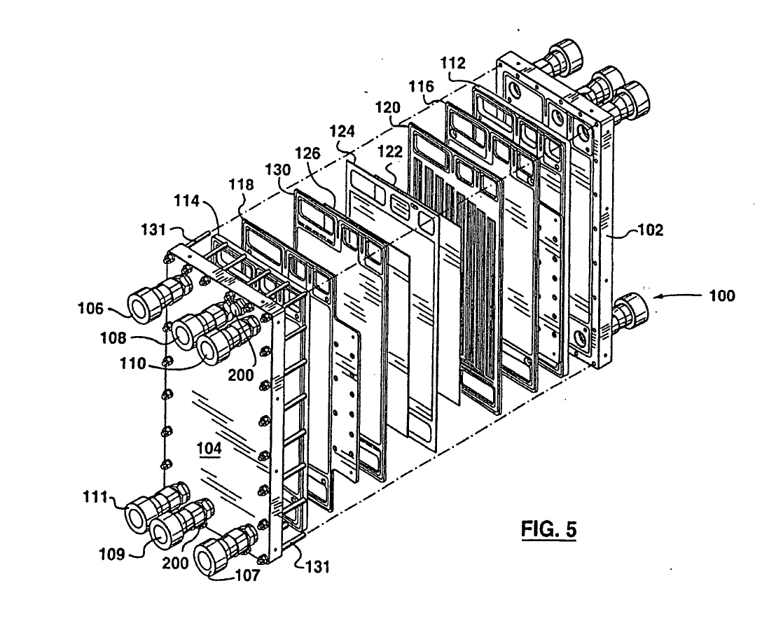

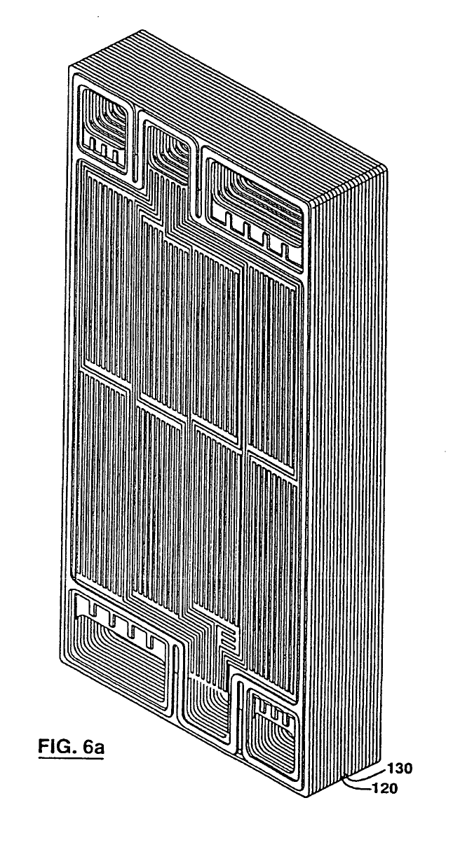

Reference will now be made to FIGS. 5-13 which show a preferred embodiment of the invention, and the fuel cell stack in these Figures is generally designated by the reference 100.

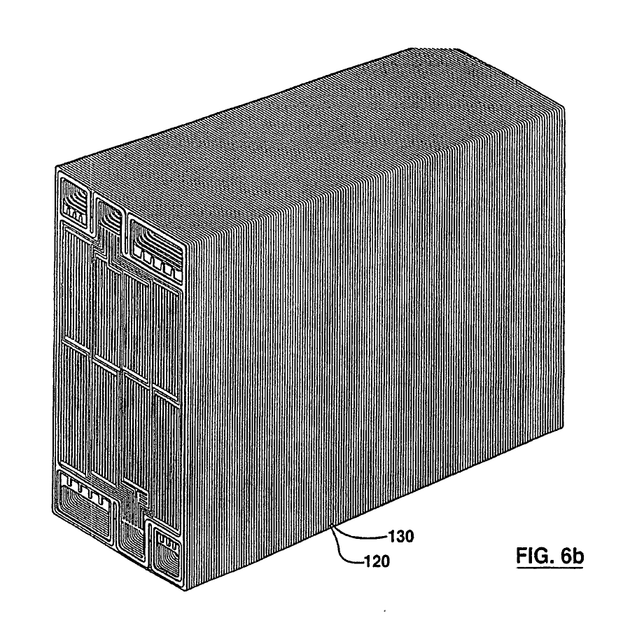

Referring first to FIGS. 5 and 6, there are shown the basic elements of the stack 100. Thus, the stack 100 includes an anode endplate 102 and cathode endplate 104. In known manner, the endplates 102, 104 are provided with connection ports for supply of the necessary fluids. Air connection ports are indicated at 106, 107; coolant connection ports are indicated at 108, 109; and hydrogen connection ports are indicated at 110, 111. Although not shown, it will be understood that corresponding air, coolant and hydrogen ports, corresponding to ports 106-111 would be provided on the anode side of the fuel cell stack 100. The various ports 106-111 are connected to distribution channels or ducts that extend through the fuel cell stack 100, as for the earlier embodiments. The ports are provided in pairs and extend all the way through the fuel cell stack 100, to enable connection of the fuel cell stack 100 to various equipment necessary. This also enables a number of fuel cell stacks to be connected together, in known manner.

Immediately adjacent the anode and cathode endplates 102, 104, there are insulators 112 and 114. Immediately adjacent the insulators, in known manner, there are an anode current collector 116 and a cathode current collector 118.

Between the current collectors 116, 118, there is a plurality of fuel cells. In this particular embodiment, there are ten fuel cells. FIG. 5, for simplicity, shows just the elements of one fuel cell. Thus, there is shown in FIG. 5 an anode flow field plate 120, a first or anode gas diffusion layer or media 122, a MEA 124, a second or cathode gas diffusion layer 126 and a cathode flow field plate 130.

To hold the assembly together, tie rods 131 are provided, which are screwed into threaded bores in the anode endplate 102, passing through corresponding plain bores in the cathode endplate 104. In known manner, nuts and washers are provided, for tightening the whole assembly and to ensure that the various elements of the individual fuel cells are clamped together.

Now, the present invention is concerned with the seals and the method of forming them. As such, it will be understood that other elements of the fuel stack assembly can be largely conventional, and these will not be described in detail. In particular, materials chosen for the flow field plates, the MEA and the gas diffusion layers are the subject of conventional fuel cell technology, and by themselves, do not form part of the present invention.

Reference will now be made to FIGS. 6a and 6b, which show configurations with respectively, 20 and 100 individual fuel cells. These Figures show the fuel cells schematically, and indicate the basic elements of the fuel cells themselves, without the components necessary at the end of the stack. Thus, endplates 102, 104, insulators 112, 114, and current collectors 116, 118 are not shown. Instead, these Figures simply show pairs of flow field plates 120, 130.

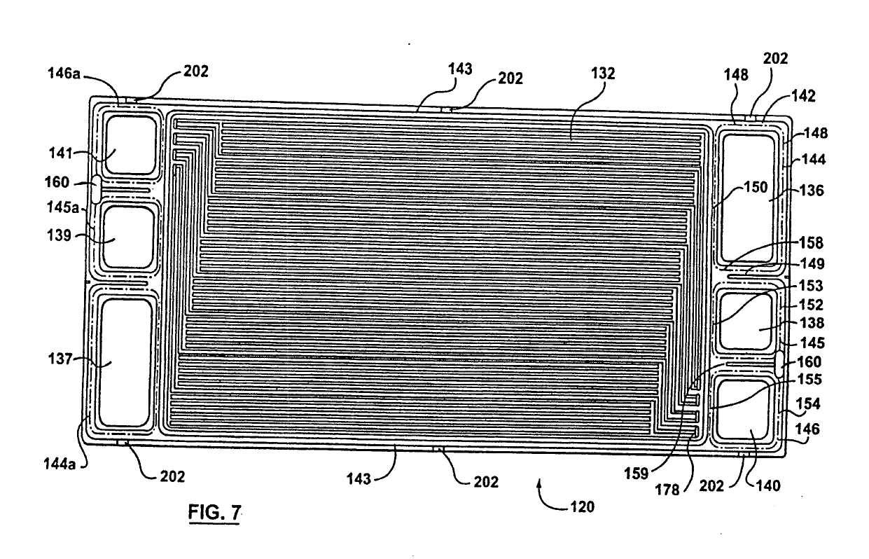

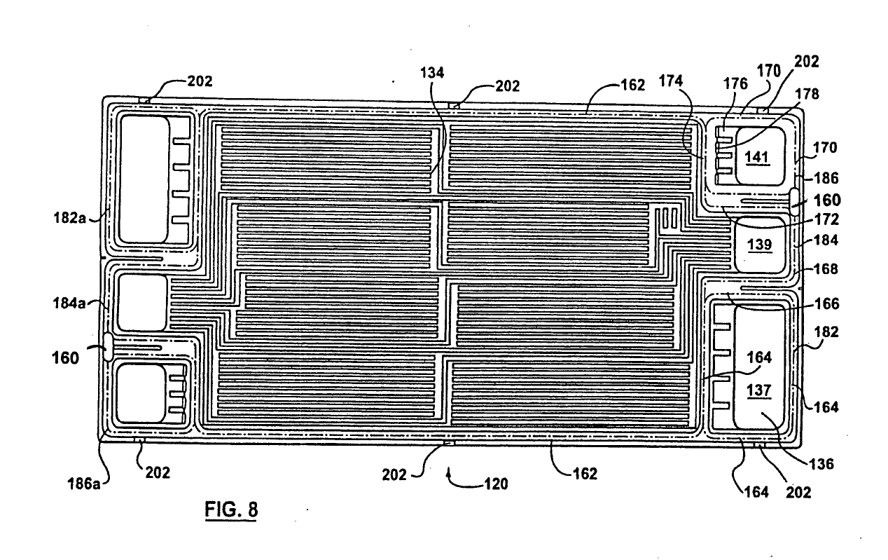

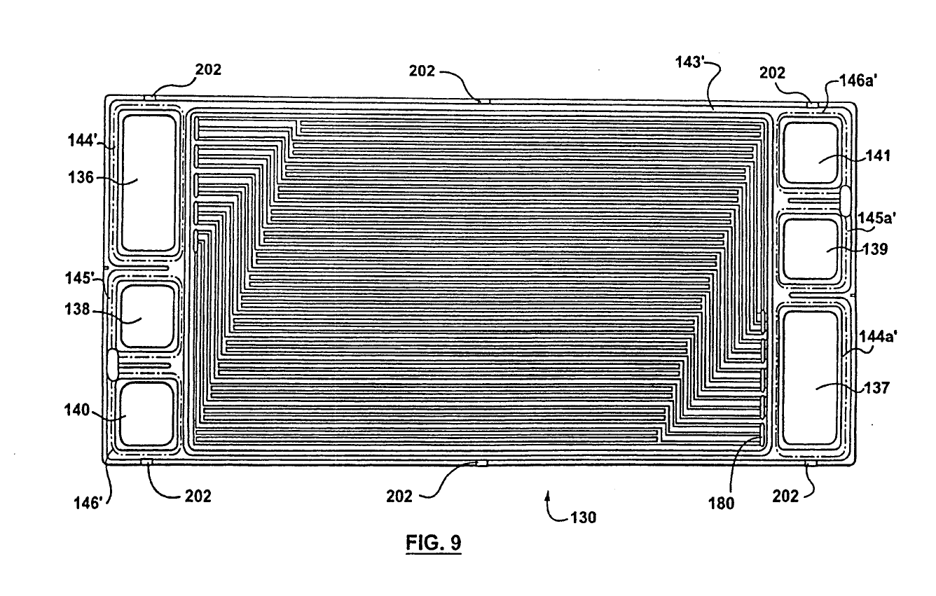

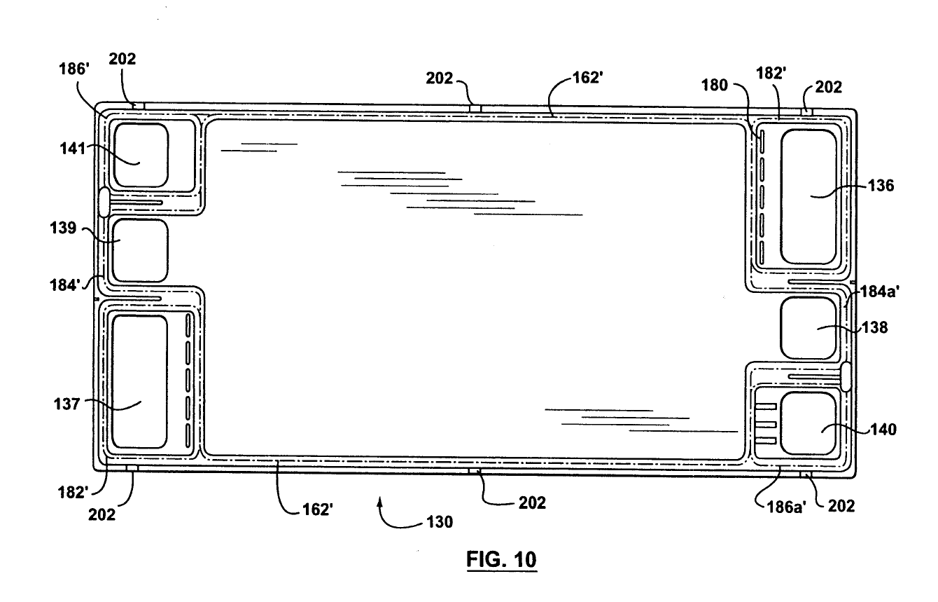

In the following description, it is also to be understood that the designations “front” and “rear” with respect to the anode and cathode flow field plates 120, 130, indicates their orientation with respect to the MEA. Thus, “front” indicates the face towards the MEA; “rear” indicates the face away from the MEA. Consequently, in FIGS. 8 and 10, the configuration of the ports is reversed as compared to FIGS. 7 and 9.

Reference will now be made to FIGS. 7 and 8 which show details of the anode bipolar plate 120. As shown, the plate 120 is generally rectangular, but can be any geometry, and includes a front or inner face 132 shown in FIG. 7 and a rear or outer face 134 shown in FIG. 8. The front face 132 provides channels for the hydrogen, while the rear face 134 provides a channel arrangement to facilitate cooling.

Corresponding to the ports 106-111 of the whole stack assembly, the flow field plate 120 has rectangular apertures 136, 137 for air flow; generally square apertures 138, 139 for coolant flow; and generally square apertures 140, 141 for hydrogen. These apertures 136-141 are aligned with the ports 106-111. Corresponding apertures are provided in all the flow field plates, so as to define ducts or distribution channels extending through the fuel cell stack in known manner.

Now, to seal the various elements of the fuel cell stack 100 together, the flow field plates are provided with grooves to form a groove network that, as detailed below, is configured to accept and to define a flow of a sealant that forms seal through the fuel cell stack. The elements of this groove network on either side of the anode flow field plate 120 will now be described.

On the front face 132, a front groove network or network portion is indicated at 142. The groove network 142 has a depth of 0.024″ and the width varies as indicated below.

The groove network 142 includes side grooves 143. These side grooves 143 have a width of 0.153″.

At one end, around the apertures 136, 138 and 140, the groove network 142 provides corresponding rectangular groove portions.

Rectangular groove portion 144, for the aperture 136, includes outer groove segments 148, which continue into a groove segment 149, all of which have a width of 0.200″. An inner groove segment 150 has a width of 0.120″. For the aperture 138 for cooling fluid, a rectangular groove 145 has groove segments 152 provided around three sides, each again having a width of 0.200″. For the aperture 140, a rectangular groove 146 has groove segments 154 essentially corresponding with the groove segments 152 and each again has a width of 0.200″. For the groove segments 152, 154, there are inner groove segments 153, 155, which like the groove segment 150 have a width of 0.120″.

It is to be noted that, between adjacent pairs of apertures 136, 138 and 138, 140, there are groove junction portions 158, 159 having a total width of 0.5″, to provide a smooth transition between adjacent groove segments. This configuration of the groove junction portion 158, and the reduced thickness of the groove segments 150, 153, 155, as compared to the outer groove segments, is intended to ensure that the material for the sealant flows through all the groove segments and fills them uniformly.

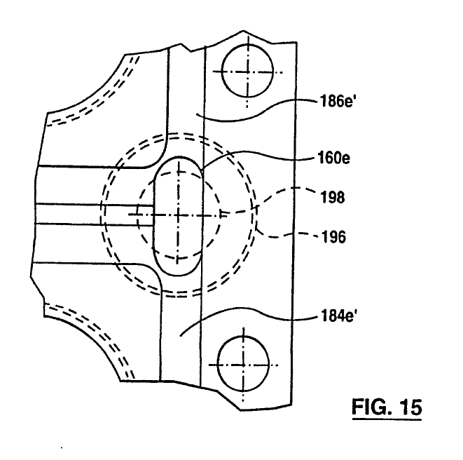

To provide a connection through the various flow field plates and the like, a connection aperture 160 is provided, which has a width of 0.25″, rounded ends with a radius of 0.125″ and an overall length of 0.35″. As shown, in FIG. 7 connection aperture 160 is dimensioned so as to clearly intercept the groove segments 152, 154. This configuration is also found in the end plates, insulators and current collection plates, as the connection aperture 160 continues through to the end plates and the end plates have a corresponding groove profile. It is seen in greater detail in FIGS. 12 and 15, and is described below.

The rear seal profile of the anode flow field plate is shown in FIG. 8. This includes side grooves 162 with a larger width of 0.200″, as compared to the side grooves on the front face. Around the air aperture 136, there are groove segments 164 with a uniform width also of 0.200″. These connect into a first groove junction portion 166.

For the coolant aperture 138, groove segments 168, also with a width of 0.200″, extend around three sides. As shown, the aperture 138 is open on the inner side to allow cooling fluid to flow through the channel network shown. As indicated, the channel network is such as to promote uniform distribution of cooling flow across the rear of the flow field plate.

For the fuel or hydrogen aperture 140 there are groove segments 170 on three sides. A groove junction portion 172 joins the groove segments around the apertures 138, 140.

An innermost groove segment 174, for the aperture 140 is set in a greater distance, as compared to the groove segment 155. This enables flow channels 176 to be provided extending under the groove segment 155. Transfer slots 178 are then provided enabling flow of gas from one side of the flow field plate to the other. As shown in FIG. 7, these slots emerge on the front side of the flow field plate, and a channel network is provided to distribute the gas flow evenly across the front side of the plate. The complete rectangular grooves around the apertures 136, 138 and 140 in FIG. 8 are designated 182, 184 and 186 respectively.

As shown in FIGS. 7 and 8, the configuration for the apertures 137, 139 and 141 at the other end of the anode flow field plate 120 corresponds. For simplicity and brevity the description of these channels is not repeated. The same reference numerals are used to denote the various groove segments, junction portions and the like, but with a suffix “a” to distinguish them, e.g. for the groove portions 144a, 145a and 146a, in FIG. 7.

Reference is now being made to FIGS. 9 and 10, which show the configuration of the cathode flow field plate 130. It is first to be noted that the arrangement of sealing grooves essentially corresponds to that for the anode flow field plate 120. This is necessary, since the design required the MEA 124 to be sandwiched between the two flow field plates, with the seals being formed exactly opposite one another. It is usually preferred to design the stack assembly so that the seals are opposite one another, but this is not essential. It is also to be appreciated that the front side seal path (grooves) of the anode and cathode flow field plates 120, 130 are mirror images of one another, as are their rear faces. Accordingly, again for simplicity and brevity, the same reference numerals are used in FIGS. 9 and 10 to denote the different groove segments of the sealing channel assembly, but with an apostrophe to indicate their usage on the cathode flow field plate.

Necessarily, for the cathode flow field plate 130, the groove pattern on the front face is provided to give uniform distribution of the oxidant flow from the oxidant apertures 136, 137. On the rear side of the cathode flow field plate transfer slots 180 are provided, providing a connection between the apertures 136, 137 for the oxidant and the network channels on the front side of the plate. Here, five slots are provided for each aperture, as compared to four for the anode flow field plate. In this case, as is common for fuel cells, air is used for the oxidant, and as approximately 80% of air comprises nitrogen, a greater flow of gas has to be provided, to ensure adequate supply of oxidant.

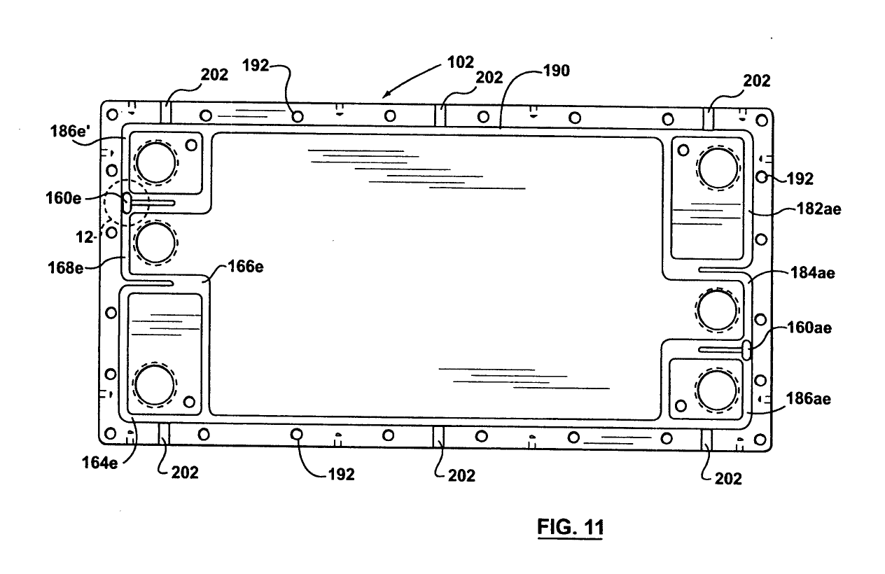

On the rear of the cathode flow field plate 130, no channels are provided for cooling water flow, and the rear surface is entirely flat. Different depths are used to compensate for the different lengths of the flow channels and different fluids within. However, the depths and widths of the seals will need to be optimized for each stack design. Reference will now be made to FIGS. 11 through 15, which show details of the anode and cathode end plates. These end plates have groove networks corresponding to those of the flow field plates.

Thus, for the anode end plate 102, there is a groove network 190, that corresponds to the groove network on the rear face of the cathode flow field plate 130. Accordingly, similar reference numerals are used to designate the different groove segments of the anode and cathode end plates 102, 104 shown in detail in FIGS. 11-13 and 14-15, but identified by the suffix “e”. As indicated at 192, threaded bores are provided for receiving the tie rods 131.

Now, in accordance with the earlier invention, a connection port 194 is provided, as best shown in FIG. 13. The connection port 194 comprises a threaded outer portion 196, which is drilled and tapped in known manner. This continues into a short portion 198 of smaller diameter, which in turn connects with the connection aperture 160e. However, any fluid connector can be used.

Corresponding to the flow field plates, for the anode end plate 102, there are two connection ports 194, connecting to the connection apertures 160e and 160ae, as best shown in FIGS. 12 and 13.

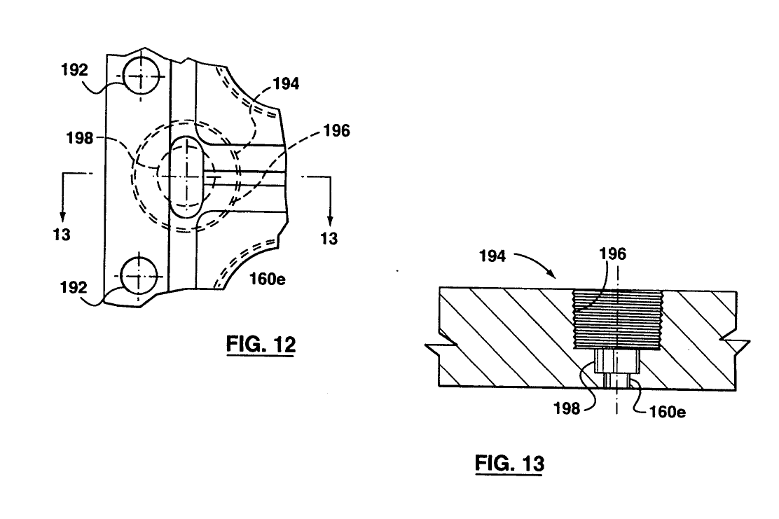

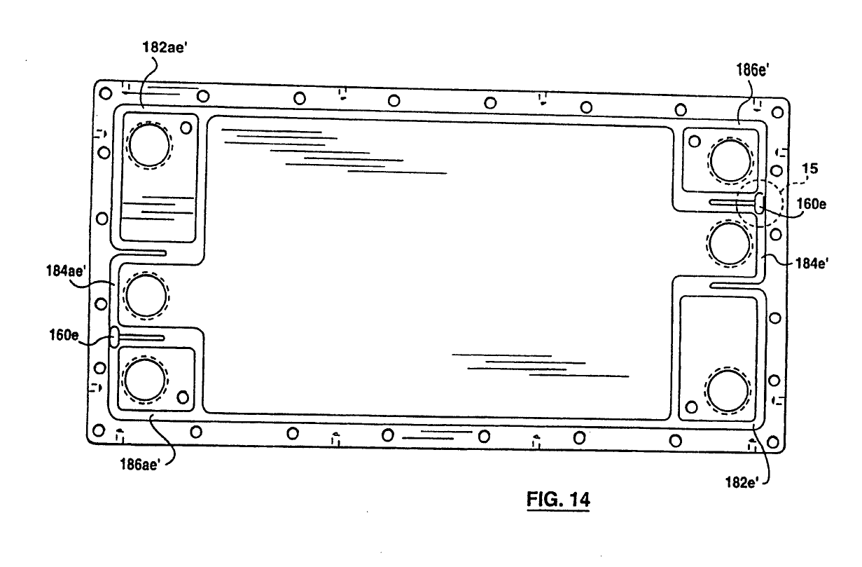

Correspondingly, the cathode end plate is shown in detail in FIGS. 14 and 15, with FIG. 15, as FIG. 12, showing connection through to the groove segments. The groove profile on the inner face of the cathode end plate corresponds to the groove profile on the rear of the anode flow field plate. As detailed below, in use, this arrangement enables a seal material to be supplied to fill the various seal grooves and channels. Once the seal has been formed, then the supply conduits for the seal material are removed, and closure plugs are inserted, such closure plugs being indicated at 200 in FIG. 5.

In use, the fuel cell stack 100 is assembled with the appropriate number of fuel cells and clamped together using the tie rods 131. The stack would then contain the elements listed above for FIG. 5, and it can be noted that, compared to conventional fuel cell stacks, there are, at this stage, no seals between any of the elements. However insulating material is present to shield the anode and cathode plates touching the MEA (to prevent shorting) and is provided as part of the MEA. This material can be either part of the lonomer itself or some suitable material (fluoropolymer, mylar, etc.) An alternative is that the bipolar plate is non-conductive in these areas.

The ports provided by the threaded bores 196 are then connected to a supply of a liquid silicone elastomeric seal material. Since there are two ports or bores 196 for each end plate, i.e. a total of four ports, this means that the seal material is simultaneously supplied from both the anode and the cathode ends of the stack; it is, additionally, supplied from both ends or edges of each of the cathode and the anode. It is possible, however, to supply from any number of ports and this is dictated by the design.

A suitable seal material is then injected under a suitable pressure. The pressure is chosen depending upon the viscosity of the material, the chosen values for the grooves, ducts and channels, etc., so as to ensure adequate filling of all the grooves and channels in a desired time.

The connection ports 194 are then closed with the plugs 200. The entire fuel stack assembly 100 is then subjected to a curing operation. Typically this requires subjecting it to an elevated temperature for a set period of time. The seal material is then chosen to ensure that it cures under these conditions.

Following curing, the fuel cell stack 100 would then be subjected to a battery of tests, to check for desired electrical and fluid properties, and in particular to check for absence of leaks of any of the fluids flowing through it.

If any leaks are detected, the fuel cell will most likely have to be repaired. Depending on the nature of the leak and details of an individual stack design, it may be possible simply to separate the whole assembly at one seal, clear out the defective seal and then form a new seal. For this reason, it may prove desirable to manufacture relatively small fuel cells stacks, as compared to other conventional practice. While this may require more inter-stack connections, it will be more than made up for by the inherent robustness and reliability of each individual fuel cell stack. The concept can be applied all the way down to a single cell unit (identified as a Membrane Electrode Unit or MEU) and this would then conceivably allow for stacks of any length to be manufactured.

This MEU is preferably formed so that a number of such MEU's can be readily and simply clamped together to form a complete fuel cell stack of desired capacity. Thus, an MEU would simply have two flow field plates, whose outer or rear faces are adapted to mate with corresponding faces of other MEU's, to provide the necessary functionality. Typically, faces of the MEU are adapted to form a coolant chamber for cooling fuel cells. One outer face of the MEU can have a seal or gasket preformed with it. The other face could then be planar, or could be grooved to receive the preform seal on the other MEU. This outer seal or gasket is preferably formed simultaneously with the formation of the internal seal, injected-in-place in accordance with the present invention. For this purpose, a mold half can be brought up against the outer face of the MEU, and seal material can then be injected into a seal profile defined between the mold half and that outer face of the MEU, at the same time as the seal material is injected into the groove network within the MEU itself. To form a complete fuel cell assembly, it is simply a matter of selecting the desired number of MEU's, clamping the MEU's together between endplates, with usual additional end components, e.g. insulators, current collectors, etc. The outer faces of the MEU's and the preformed seals will form necessary additional chambers, especially chambers for coolant, which will be connected to appropriate coolant ports and channels within the entire assembly. This will enable a wide variety of fuel cell stacks to be configured from a single basic unit, identified as an MEU. It is noted, the MEU could have just a single cell, or could be a very small number of fuel cells, e.g. 5. In the completed fuel cell stack, replacing a failed MEU is simple. Reassembly only requires ensuring that proper seals are formed between adjacent MEU's and seals within each MEU are not disrupted by this procedure.

The embodiments described have groove networks that include groove segments in elements or components on either side of the element or component. It will be appreciated that this is not always necessary. Thus, for some purposes, e.g. for defining a chamber for coolant, it may be sufficient to provide the groove segments in one flow plate with a mating surface being planar, so that tolerances are less critical. The invention has also been described as showing the MEA extending to the edges of the flow field plates. Two principal issues are to be noted. Firstly, the material of the MEA is expensive and necessarily must be quite thin typically of the order of one to two thousands of an inch with current materials, so that it is not that robust. For some applications, it will be preferable to provide a peripheral flange or mounting layer bonded together and overlapping the periphery of the PEM itself. Typically the flange will then be formed from two layers each one to two thousands of an inch thick, for a total thickness of two to four thousands of an inch. It is this flange or layer which will then be sealed with the seal.

A second consideration is that providing the MEA, or a flange layer, bisecting a groove or channel for the seal material may give problems. It is assumed that flow of the seal material is uniform. This may not occur in practice. For example, if the MEA distorts slightly, then flow cross-sections on either side will distort. This will lead to distortions in flow rates of the seal material on the two sides of the MEA, which will only cause the distortion to increase. Thus, this will increase the flow on the side already experiencing greater flow, and restrict it on the other side. This can result in improper sealing of the MEA. To avoid this, the earlier invention also anticipates variants, shown in FIGS. 1b-1e. These are described below, and for simplicity like components in these figures are given the same reference numerals as in Figure la, but with the suffixes b, c, d as appropriate, to indicate features that are different.

A first variant, in FIG. 1b, provides a configuration in which the periphery of the MEA 26b, or any mounting flange, is dimensioned to terminate at the edge of the groove itself, i.e. the MEA 26b would not extend all the way across the groove. This will require more precise mounting of the MEA 26b. Additionally, it would mean that mating surfaces of endplates and the like, outside of the groove network would not then be separated by the MEA. To obtain insulation between the flow field plates, a separate layer of insulation, indicated at 27 would be provided, for example, by screen printing this onto the surface of flow field plates 22b and 24b. As shown, the grooves 28b, 30b can be largely unchanged.

A second variant, in FIG. 1c, overcomes the potential problem of different flow rates in opposed grooves causing distortion of the MEA, by providing offset grooves, shown at 28c, 30c. In this arrangement, each groove 28c in the plate 22c would be closed by a portion of the MEA 26c, but the other side of that portion of the MEA 26c would be supported by the second plate 24c, so as to be incapable of distortion. Correspondingly, a groove 30c in the second plate 24c, offset from the groove 28c in the plate 22c, would be closed by MEA 26c, and the MEA 26c would be backed and supported by the plate 22c.

Referring to FIG. 1d, in a further variant, the GDM cavities 38 are effectively removed, by providing GDM layers that extend to the peripheries of the plates 22d and 24d. The grooves 28d, 30d are still provided as shown, opening onto edges of the GDM layers. The seal then flows out of the grooves 28d, 30d, to fill the voids in the GDM, until the seal material reaches the surface of the MEA 26d. It is expected that the seal material will flow around individual particles of the catalyst layer, so as to form a seal to the actual proton exchange membrane, even if the seal material does not fully penetrate the catalyst layer. As required, the MEA 26d layer can terminate either flush with the peripheries of the plates 22d, 24d, or set in from the plate peripheries; in the later case, a seal, itself flush with the plate peripheries, will effectively be formed around the outer edges of the MEA 26d and the GDM layers. In either case, it is possible to provide an extension of the seal, outside of the grooves 28d, 30d and beyond the plate peripheries, possibly extending around the fuel cell stack as a whole.

In FIG. 1e, the construction is similar to FIG. 1d. However, the GDM layers terminate short of the plate peripheries as indicated at 31e. The grooves 28e, 30e are then effectively formed outside of the GDM layers to the peripheries of the plates 22e, 24e.

In FIG. 1d and 1e, the anode and cathode flow field plates have flat, opposing faces, although it will be understood that these faces, in known manner, would include flow channels for gases. As these faces are otherwise flat, this greatly eases tolerance and alignment concerns, and in general it is expected that the MEA 26d,e can be inserted without requiring on any tight tolerances to be maintained.

In all of FIGS. 1a-1e, the PEM layer 26a-e can be replaced with a PEM layer that has an outer mounting flange or border. This usually makes the PEM layer stronger and saves on the more expensive PEM material. This has advantages that the flange material can be selected to form a good bond with the seal material, and this avoids any potential problems of forming a seal involving the catalyst layers.

In FIGS. 1d and 1e, facing projections can be provided around the outer peripheries of the plates to control spacing of the plates and hence pressure on the GDM layers without affecting flow of the seal material. These can additionally assist in aligning the PEM layers 26 and the GDM layers. Alternatively, projections can be omitted, and the entire stack clamped to a known pressure prior to sealing. Unlike known techniques, all the pressure is taken by the GDM layers, so that each GDM layer is subject to the same pressure. This pressure is preferably set and maintained by tie rods or the like, before injecting the seal material.

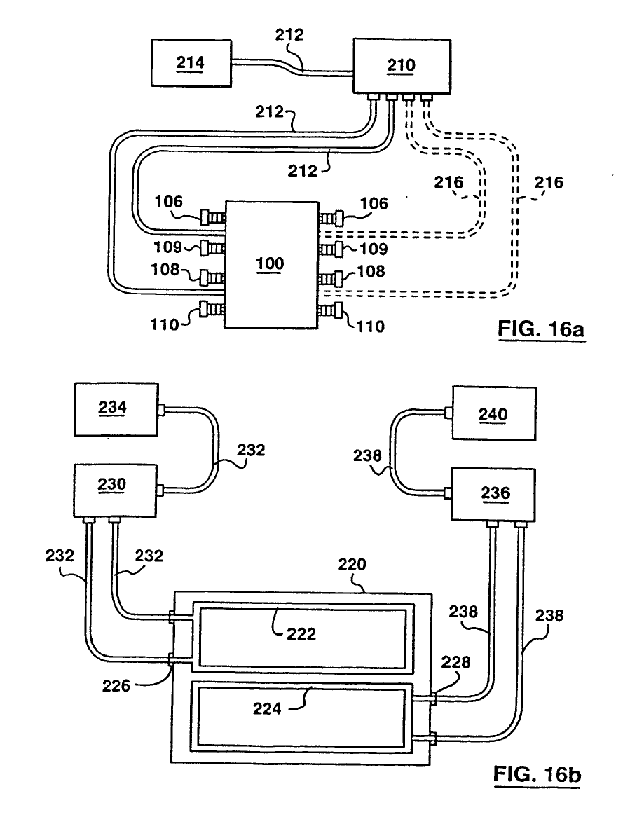

Referring now to FIGS. 16a and 16b, there is shown schematically the overall arrangement for supplying the seal material with FIG. 16b showing an arrangement for supplying two different seal materials.

In FIG. 16a, the fuel cell stack 100 of FIG. 5 is shown. A pump 210 is connected by hoses 212 to two ports at one end of the fuel cell stack 100. An additional hose 212 connects the pump 210 to a silicone seal material dispensing machine, that includes a static mixer, and which is indicated at 214.

In this arrangement, the seal material is supplied to just from one end of the stack 100. As such, it may take some time to reach the far end of the stack, and this may not be suitable for larger stacks. For larger stacks, as indicated in dotted lines 216, additional hoses can be provided, so that the seal material is supplied from both ends of the stack 100. As detailed elsewhere, the material is supplied at a desired pressure, until the stack is filled, and all the air has been displaced from the stack.

Referring to FIG. 16b, this shows an alternative fuel cell stack indicated at 220. This fuel cell stack 220 has two separate groove networks indicated, schematically at 222 and 224. The groove network 222 is connected to ports 226 at one end, while the groove network 224 is connected to ports 228 at the other end. The intention here is that each groove network would be supplied with a separate seal material, and that each seal material would come into contact with different elements of the fuel cell stack. This enables the seal materials to be tailored to the different components of the fuel cell stack, rather than requiring one seal material to be compatible with all materials of the stack.

For the first groove network 222, there is a pump 230 connected by hoses 232 to a fuel cell stack 220. One hose 232 also connects the pump 230 to a dispensing machine 234. Correspondingly, for the second groove network 224, there is a pump 236 connected by hoses 238 to the stack 220, with a hose 238 also connecting a second dispensing machine 240 to the pump 236.

In use, this enables each groove network 222, 224 to be filled separately. This enables different pressures, filling times and the like selected for each groove network. For reasons of speed of manufacture, it is desirable that the filling times be compatible, and this may necessitate different pressures being used, depending upon the different seal materials.

It is also possible that different curing regimes could be provided. For example, one groove network can be filled first and cured at an elevated temperature that would damage the second seal material. Then, the second groove network is filled with the second seal material and cured at a different, lower temperature. However, in general, it will be preferred to fill and cure the two separate groove networks 222, 224 simultaneously, for reasons of speed of manufacture.

While separate pumps and dispensing machines are shown, it will be appreciated that these components could be integral with one another.

While the earlier invention is described in relation to proton exchange membrane (PEM) fuel cell, it is to be appreciated that the invention has general applicability to any type of electrochemical cell. Thus, the invention could be applied to: fuel cells with alkali electrolytes; fuel cells with phosphoric acid electrolyte; high temperature fuel cells, e.g. fuel cells with a membrane similar to a proton exchange membrane but adapted to operate at around 200° C.; electrolysers; regenerative fuel cells and (other electrochemical cells as well.) The concept would also be used with higher temperature fuel cells, namely molten carbonate and solid oxide fuels but only if suitable seal materials are available.

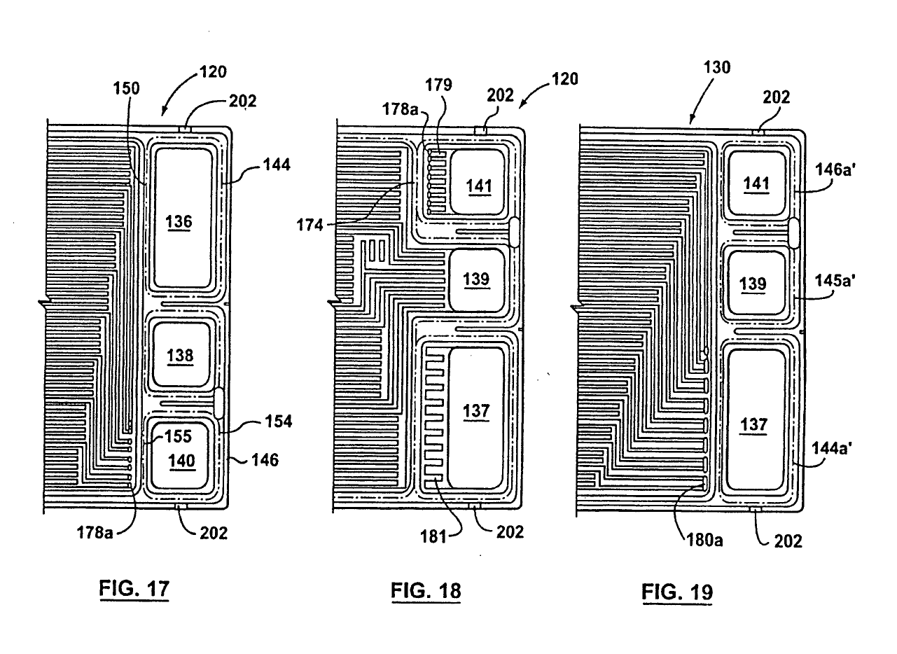

FIGS. 17, 18, 19 and 20 show alternative rib configurations for the plates. Here, the number of ribs adjacent the apertures for the fuel and oxygen flows, to provide a “backside” feed function, have essentially been approximately doubled. This provides greater support to the groove segment on the other side of the plate.

In FIGS. 17-20, the transfer slots are denoted by the references 178a, for the anode plate 120, and 180a, for the cathode plate 130. The suffixes indicate that the transfer slots have different dimensions, and are more numerous. There are eight transfer slots 178a, as compared to four slots 178, and there are eight transfer slots 180a, as compared to four slots 180. It will also be understood that it is not necessary to provide discrete slots and that, for each flow, it is possible to provide a single relatively large transfer slot. Each of the slots 178a communicates with a single flow channel (FIG. 17), and each of the slots 180a communicates with two flow channels, except for an end slot 180a that communicates with a single channel (FIG. 19).

The transfer slots 178a are separated by ribs 179, and these are now more numerous than in the first embodiment or variant. Here, the additional ribs 179 provide additional support to the inner groove segment on the front face of the anode plate (FIG. 17, 18). Similarly, there is now a larger number of ribs, here designated at 181, between the slots 180a, and these provide improved support for the groove segment 150 (FIGS. 17, 18).

It will also be understood that, as explained above, facing rear faces of the anode and cathode plates abut to form a compartment for coolant. Consequently, the ribs 179 and 181 abut and support the cathode plate to provide support for the inner groove segments around the apertures 137 and 141 of the cathode plate 130 (FIG. 18).

With reference to FIGS. 22a and 22b, there is shown a fuel cell stack indicated schematically at 300, in accordance with the present invention. The stack 300 includes a plurality of individual cells 302, insulator plates 304 and end plates 306, with current collection plates between the insulator plates 304 and the cells 302 in known manner.

In accordance with the present invention, the fuel cell stack 300 is provided with a groove network extending through the fuel cells 302, and as required, through the current collector plates and end plates 306, to enable the various components to be sealed with respect to one another. To supply the seal material, a connection port is provided on the side of one end plate 306 and is connected through by a transverse duct 308, which can be connected to two or more main manifolds 310 as required.

Details of the groove network are not shown in FIGS. 22a and 22b, where there is shown a main groove manifold 310 extending perpendicularly through the various plates 304 and other elements of the stack 300.

With reference to the previous drawings, this main manifold 310 may be formed from the apertures 160, although for reasons detailed below the apertures 160 are given a different configuration in this embodiment. As shown, the main manifold 310 has a main portion 311 of relatively large cross section and a second portion 312 of smaller diameter.

For purposes of initially filling the groove network with seal material and curing the seal material, with reference to FIG. 22a, there is provided an apparatus including a connector 314, an adapter 316 for connecting components of different diameter, connecting the connector 314 to a short tube section 318 of relatively larger diameter. A first ferrule 320 is located in the tube section 318 and a second ferrule 321 is located in a recess 322 located in the bottom end plate 306, as shown. A rod 324 is threaded and engages the ferrules 320, 321 in known manner, the ferrules 320, 321 being tightened to put the rod 324 into slight tension. This ensures that the rod 324 is centered within the main manifold 310, and the ferrules 320, 321 provide seals.

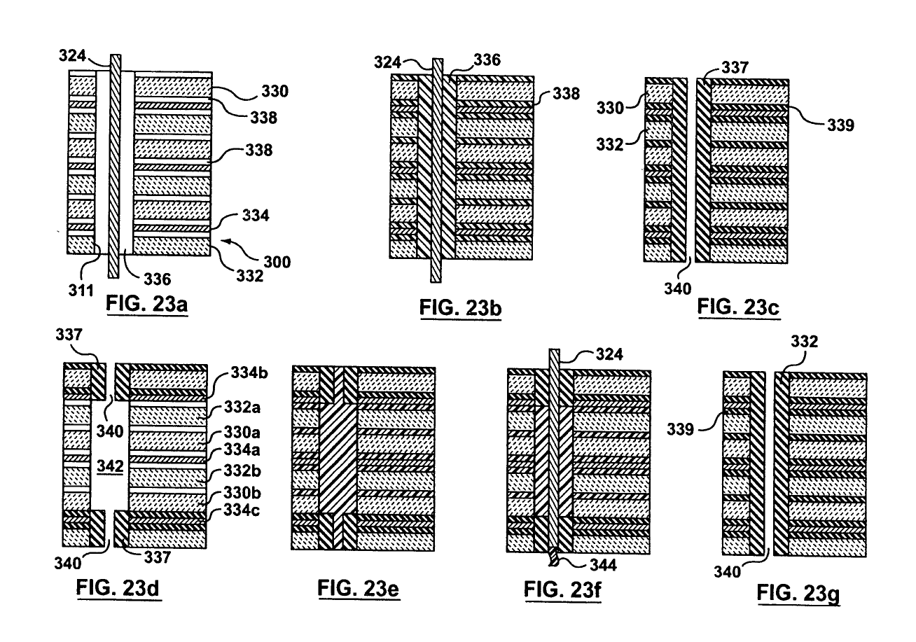

Reference will now be made to FIGS. 23a, 23c, which show the fill sequence for initial filling and sealing of the cell stack 100. In FIG. 23, individual cathode plates are indicated at 330 and individual anode plates are indicated at 332, with the membrane exchange assembly (MEA) for each cell indicated at 334.

FIG. 23a shows the cell stack 300, in part, before the seal material is injected. The rod 324 is shown centered in the main portion 311 of the main groove manifold 310 (FIG. 22a), so as to define an annular space 336 for the seal material. FIG. 23a additionally shows, schematically for exemplary purposes, empty grooves 338, between the membrane exchange assembly 334 and the adjacent anode and cathode plates 332, 330, and also between facing pairs of the plates 330, 332, as detailed above in relation to earlier figures.

FIG. 23b then shows the configuration after the seal material has been injected into the stack 300. The annular space 336 and the grooves 338 are then all filled with the seal material, in an uncured state. As detailed above, for a silicone-type material, it is then necessary for this to be cured; alternatively, if a thermoplastic is used, this will have been injected at an elevated temperature and curing or setting of the material then simply requires cooling to a lower temperature.

FIG. 23c then shows the stack 300 after the seal material has been cured. By this time, the rod 324 has been removed. As shown in FIG. 23c, the grooves 338 have been filled with seal material indicated at 339 and the annular space 336 is correspondingly filled with an annular plug of the seal material indicated at 337, leaving a bore 340 extending through the annular plug of seal material 337. As detailed below, this enables repair of seals to individual cells to be made, while not affecting seals for cells that do not require repair.

Referring back to FIG. 22b, this shows a variant of the apparatus of FIG. 22a, adapted for repairing cells within a cell stack. In FIG. 22b, the rod 324 and its corresponding ferrules 320, 321 have been removed. Instead, there is a socket set screw 326. At the top of the fuel cell stack 300, shown in FIG. 22b, the connector 314 is again provided, but it is simply connected to appropriate adapters or elements 328 for connection to a source of the seal material. This is to enable seal material to be provided through the bore 340, since the transverse duct 308 is filled with set seal material, after initial assembly.

Referring now to FIGS. 23d-23g, there is shown a sequence for effecting repair in a fuel cell stack. As is known, the fuel cell stack 300 can include many cells, even hundreds of cells. At any stage in the life of the fuel cell stack 300, one or more of the seals or other elements of the cells in the stack 300 may fail. The present invention enables such failed cells to be repaired, while not disrupting other cells in a state of good repair.

When a failed cell is located, individual plates 330, 332 on either side of that seal are separated, to enable it to be repaired. The existing seal material on the exposed sides of the portions of the stack 300 that are to be repaired is removed using appropriate means. Practically, it has been found possible to readily separate the stack 300 at the membrane electrode assembly 334 between pairs of plates 330 and 332 of a single cell. This can be achieved by sliding a knife carefully between the plates 330, 332. However, when plates 330, 332 from adjacent cells abut one another, thereby defining a coolant chamber, and do not have the MEA 334 between them, it is more difficult to separate these plates within the stack 300 itself. It may be possible to separate these once the pairs of such plates are removed from the stack 300, although this is not possible to applicants' knowledge with known plates; accordingly, they are simply replaced. If a release agent is used in these areas or the adhesion is adjusted appropriately (an alterable quality of the sealant) it can be released. However, it may not always be practical.

Thus, FIG. 23d shows a repair in which two cathode plates 330a and 330b together with two anode plates 332a and 332b are separated from the stack and replaced, or if possible, their respective seals repaired and replaced. The plate pair 330a, 332b has an MEA 334a therebetween, and it is assumed that there is some seal failure in the seal to the MEA 334a (Note here that there are other failures, e.g. failure of an MEA or a plate, that can be repaired by this technique). As explained above, practically, the fuel cell stack 300 has been found to be more easily separable at the MEA 334, and hence the stack is separated at the two MEAs indicated at 334b and 334c immediately adjacent the MEA 334a.

With some care and skill, it has proved possible to separate the stack at individual MEAs and to leave the MEAs intact. Where this is not possible, then the MEAs 334b, 334c would be replaced, and grooves on the adjacent and retained plates of the stack cleared out, to seal two new MEAs.

With the stack separated at the MEAs 334b, 334c, the four plates 330a, 330b, 332a, and 332b, can then be separated or replaced as desired, as can the MEA 334a. The stack 300 is then reassembled, shown in FIG. 23d, and as shown, the annular plug of seal material 337 will then show a discontinuity in the plates 330a, 330b, 332a, and 332b, leaving a bore section 342. This bore section 342 is shown in communication with the smaller bore 340. Hence, using the apparatus in FIG. 22b, seal material can be injected through the bore 340 and bore section 342 into the grooves 338 between the various elements 330a, 330b, 332a, and 332b, and the MEAs 334a, 334b and 334c. The seal material can then be cured and set as described above.

While this technique can be used for a one time repair, it will be appreciated that the bore 340 has then been filled with seal material which is cured, so that there is then, no longer, an unobstructed bore through the stack 300 for repair of individual seals. This arrangement is shown in FIG. 23e.

A preferred alternative, as shown in FIG. 23f, is to reinsert the rod 324 after the bore section 342 and the grooves 338 for the repaired section have been filled with material. As shown schematically in FIG. 23f, the rod 324 then displaces excess seal material as indicated at 344. Then, as for the original seal process, the seal material is cured or allowed to set, and the rod 324 can then be removed, to leave the bore 340 substantially reformed. This is shown in FIG. 23g where it will be appreciated that the stack 300 is then essentially in the same condition as the originally formed and sealed stack shown in FIG. 23c. If a further cell should fail, it is then possible to repair this individual cell using the sequence just described, as the bore 340 is available for delivery of seal material to any cell or cells within the stack 300.

To enable the rod 324 to be readily removed after forming the seal, either when forming the initial seal for the whole stack or during repair of the stack, it is preferred to ensure that the rod 324 has a smooth, polished surface and that it is coated with a release agent. Additionally, for the repair process, in a large stack, it may be desirable to shape the end of the rod 324, to assist in guiding it through the parts of the bore 340 that remain. For example, the end of the rod 324 can be rounded or tapered, so that it does not damage the portions of the annular plug 337 defining the bore 340.

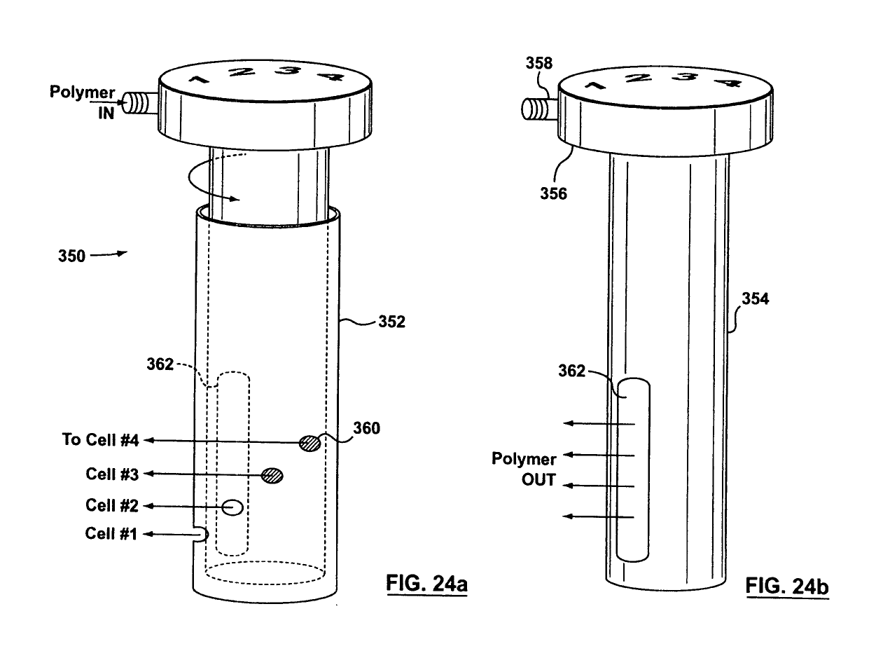

Reference will now be made to FIGS. 24-27 which show a variant apparatus for carrying out the present invention.

Referring first to FIGS. 24a and 24b, there is shown an injection device or apparatus 350 that comprises an outer cylinder 352 and an inner cylinder 354, provided with an actuating knob 356 and a connection 358 for supply of the seal material.

The outer cylinder 352 includes a series of apertures 360, which are staggered both vertically and circumferentially around the cylinder 352. The inner cylinder 354 has a vertically extending slot, shown in FIG. 24b, indicated at 362. As shown in FIG. 24a, the slot 362 can be aligned with one of the apertures 360.

In use, when seal material supplied through the connection 358 to the interior of the inner cylinder 354, this arrangement ensures that the seal material is permitted only to flow out to one of the selected apertures 360. Accordingly, this arrangement enables seal material to be supplied to just one aperture 360 for supplying seal material to just one cell, or possibly group of cells, within a cell stack. Rotation of the actuating knob 356 enables the desired cell or group of cells to be selected.

It is also possible for the inner cylinder to include an additional slot, opposite to the vertically extending slot 362 that is angled or helical, so as to be capable of alignment with all the apertures 360. This additional slot would be used during original manufacture to fill all the grooves etc. simultaneously.

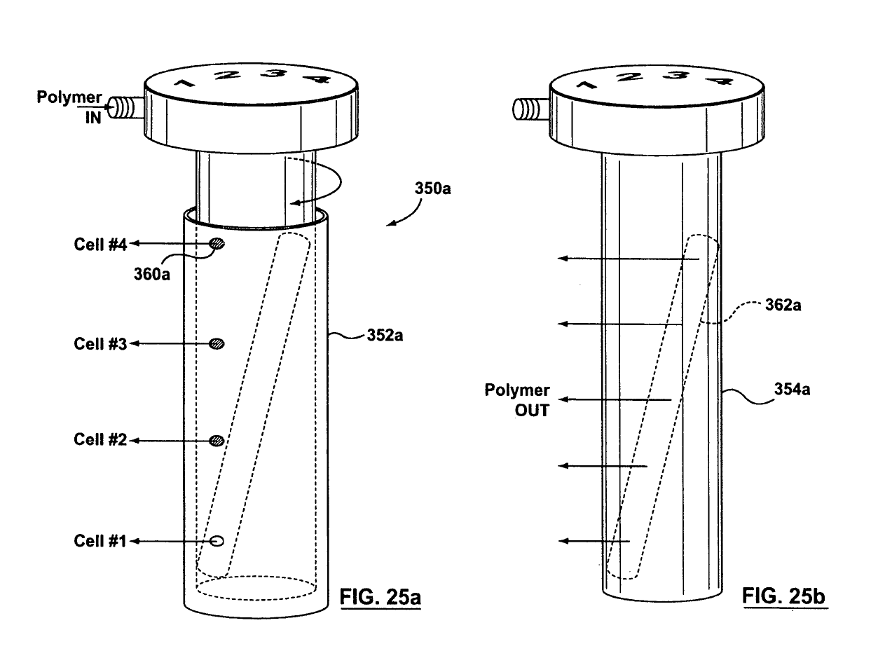

FIGS. 25a and 25b show a variant of the injection apparatus 350, where like components are given the same reference numeral as shown in FIG. 24 but with the suffix a. Thus, the apparatus 350a has an outer cylinder 352a including apertures 360a. Here, the apertures 360a are aligned vertically. For the inner cylinder 354a, the slot 362a is now angled or inclined so as to follow a helical path around the inner cylinder 354. In operation, the aperture 350a functions in exactly the same manner as the apparatus 350 of FIG. 24, enabling a selected one of the apertures 360a to be aligned with the slot 362a. Like the FIG. 24 variant, a single vertical slot can also be provided that can be aligned with all the apertures 360a simultaneously, for initial filing of all grooves in a cell stack.

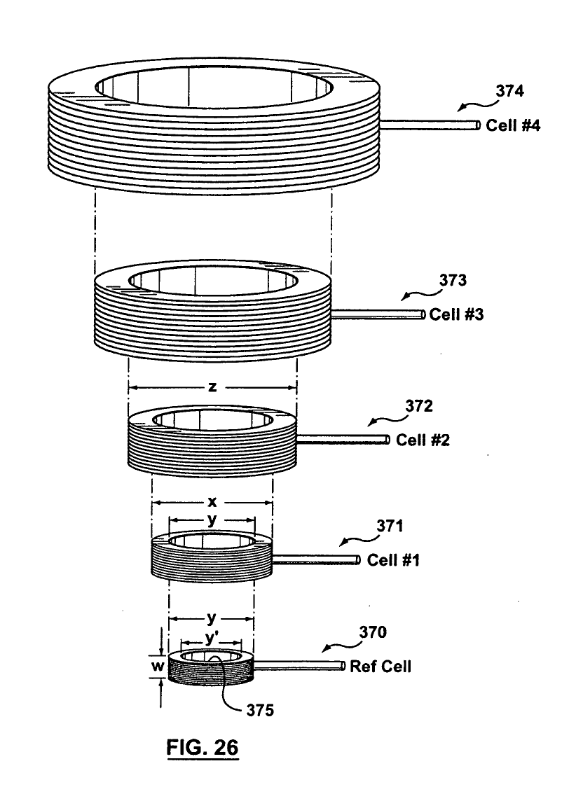

Referring now to FIG. 26, there is shown a further alternative procedure and apparatus for sealing and later repairing the fuel cell stack 300, where the connection apertures 160 in each pair of plates for each cell are sized differently. As for the earlier embodiments of FIGS. 22-25, it is envisaged that the apertures in the plates would be circular, rather than elongate.

FIG. 26 shows five exemplary plate cells indicated as a reference cell 370 and cells 1 to 4 indicated at 371, 372, 373 and 374. For each plate 370-374, just part of a plate is shown. The plates 370-374 are shown spaced apart, to accommodate intervening layers, such as MEA and GDM layers, with this spacing being schematic; it will be understood that usually the plates themselves are much thicker than any intervening layer. Also, a bore is shown for each plate or cell 370-374 and each bore is shown defined by an annulus of plate material, this is schematic and as in early drawings, each plate would be extensive, with the bore having smaller dimensions than the plate itself. Also, connections to grooves or groove materials are indicated schematically on the right hand side of FIG. 26.

While FIG. 26 can be understood to show five plates for the cells 370-374, it is also possible that each of the references 370-374 could correspond to a complete single cell, with two plates, or a group of cells. In the later case, the intention is that repair is to be effected by exchanging a complete group of cells.

Although details of the cells are not fully shown, the reference cell 370 has an aperture 375, corresponding to a seal in the aperture 160 of the earlier embodiments, in its anode and cathode plates with an inner diameter y′ and an overall height of the aperture 375 within the reference cell 370 is indicated as W. The next cell or plate, i.e. the first cell 371, has a larger diameter aperture in its plates, MEA, etc. with a diameter y as shown, being larger than y′. As shown, the other three cells, 372, 373 and 374 each have a correspondingly large diameter, x, z, etc.

In use, during initial assembly and manufacture, the bores or apertures through the various through the various cells or plates 370-374 shown in FIG. 26 are filled with a suitable seal material, somewhat similar to the manner described above in relation to FIG. 22a, with a seal material filling the bores or apertures shown in FIG. 26 in the same manner as for the main groove manifold 310. Before the seal material sets, whether it be with thermoset or thermoplastic material, a plunger is inserted to ensure that each of the bores in the plates or cells 370-374 is left clear and unobstructed as shown in FIG. 26. It will be appreciated that such a plunger will thus need to be stepped and have a series of cylindrical portions, each having a diameter corresponding to the diameters y, y′, etc. Once the seal material is set, then the plunger is removed, and for this purpose the plunger would be coated with a release agent.

In use, any one of the individual plates 370-374, or cell or groups of cells 370-374 as the case may be, can be removed and replaced. For example, to repair and replace the plate or cell indicated at 371, the cell stack would be separated above and below the plate or cell 371, and the plate or cell 371 would be replaced or repaired, and the stack reassembled.

To reform the seal and to ensure that seal material is supplied to just the plate or cell 371, a tube of external diameter x and internal diameter y would be inserted down through the stack of cells, until it slides, in a sealing manner through the aperture in the plate or cell 372, with diameter x, and comes into abutment with the top of the plate or cell 371. Then, a rod would be inserted through this tube, the rod having a diameter y′, the rod being inserted until it engages the aperture in the plate or cell 370, so as to seal off the reference cell 370, and any part of the stack below this, from the seal material. The liquid seal material would then be injected through the annular aperture between the tube and the rod, and it will then be appreciated that the seal material can then only flow into the or each groove network indicated schematically extending from the plate or cell 371. (While the schematic indication shows just a single connection, it will be appreciated that there can be connections to different parts of the same groove network or two or more separate groove networks.)

Once all the grooves have been filled with the seal material, the tube and rod are removed. If desired, a plunger, as used for initial assembly can be reinserted, to ensure that the entire bore of the plate or cell 371 is free of seal material. The seal material is then permitted or caused to set.

It will be understood that repairs to seals in any individual cell can be effected in the same manner. The provision of a tube of an appropriate diameter ensures that the plate or cells in the upper part of the cell stack are isolated from the seal material; similarly, insertion of the rod into the aperture in the plate or cell immediately below that being repaired similarly ensures that the seal material is cutoff from or prevented from flowing down to the elements of the cell stack below the plate or cell layer being repaired.

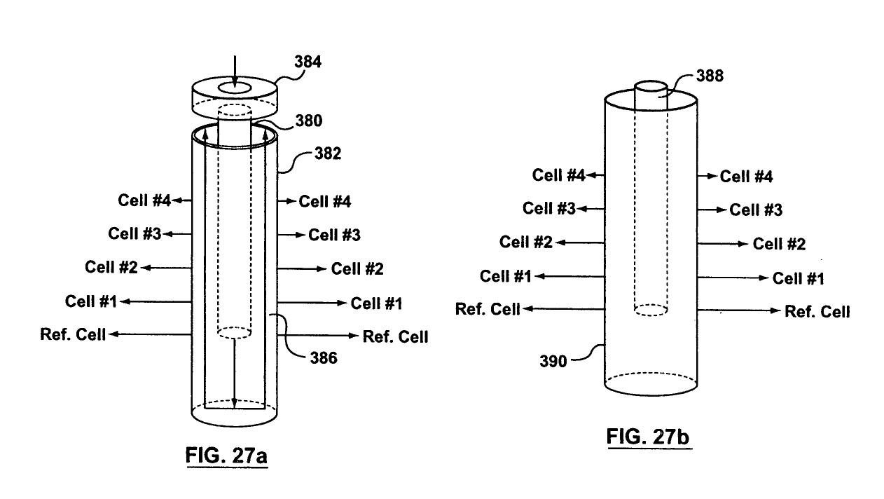

FIGS. 27a and 27b show an alternative to providing the rod 324 extended through the fuel cell stack. As these figures show, schematically, a tube 380 can be provided extending within a bore 382 in a fuel cell stack. The bore 382 corresponds to the main groove manifold 310 described above and formed by the apertures in individual cell plates and membranes. The top 384 of the tube 380 may be aligned, e.g. by elements secured to the top of the cell, such as the ferrules 320, 321 described above.

In use, the seal material is injected down through the tube 380 and will then flow up through the annular space indicated at 386, and then out to fill the individual grooves in individual cells. When all the grooves are completely filled, the tube 380 is removed, to leave a bore 388, shown in FIG. 27b, surrounded by an annular plug 390 of seal material.

As described in relation to FIGS. 23d-23g, the presence of this bore 388, then facilitates repair of the stack, in the manner described in FIGS. 23d-23g.

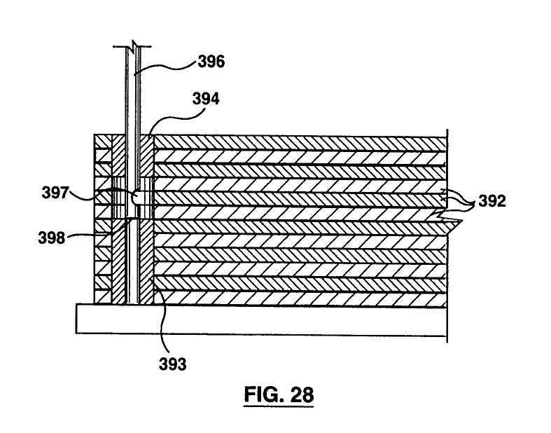

FIG. 28 shows a further embodiment of the present invention, which can be considered as a variant of the repair technique shown in FIG. 23. In FIG. 28, individual plates of a cell stack are indicated at 392, and these define the main manifold 393. Annular plugs of seal material are shown at 394, above and below a bore section 395 in the group of the plates 392 that have been replaced.

Now, to ensure that seal material is provided just to this bore section 395, a tube 396 is inserted, which includes an opening 397 and is closed at its end 398. The tube 396 provides a sealing fit within the annular plugs 394. Liquid seal material is supplied through the tube 396 and its opening 397, so as to fill the bore section 395 and flow into the groove networks of the replaced plates 392, to be repaired.

Once the seal material has set, then the tube 396 can be removed, and it will be appreciated that there should then be an essentially continuous bore through the stack of plates 392, as in earlier embodiments.

This and other embodiments are applicable to the use of various seal materials, including silicone-based materials that are cured by heat or otherwise, and also to the use of thermoplastic seal materials, which are injected at an elevated temperature, and then allowed to cool and set.

Indeed, the use of thermoplastic seal materials offers advantages over silicone materials in some respects. For example, where a thermoplastic material is used, it may not be necessary to retain a bore, such as the bore 340 of FIG. 23, to enable a seal to be repaired. The reason for this is that any thermoplastic material can be removed by heating. If no bore is present, it should be possible to insert a heated tube, which locally melts the seal material, which can then be withdrawn, so as to form a required bore. Then, this bore and seal grooves to be refilled and resealed can then be filled with seal material in the manner described in FIG. 23 and allowed to set. Again, for thermoplastic material, it is not necessary to leave a bore 340 for any subsequent repair, and as required, the bore can be reformed in the manner just described, when required.

It should be understood that various modifications can be made to the embodiments described and illustrated herein, without departing from the invention, the scope of which is defined in the appended claims. Furthermore, it should be understood that the term set indicates that the sealant material has hardened to form a seal in the fuel cell stack regardless of whether the seal material is a silicone-based material or a thermo-plastic based material. It should further be understood that the invention is applicable to electrochemical cell stacks in general which includes fuel cell stacks and electrolyzers.

While the invention has been described in relation to a fuel cell stack, or more generally an electrochemical cell assembly, in which a bore is preformed, during manufacture or assembly of the stack, in its broadest sense the invention does not necessarily require such a bore to be preformed. As mentioned, at least for thermoplastic material, it is possible that any main manifold, extending through the stack of plates or the like, could be completely filled with a seal material. Then, it can simply be removed by melting.

It should also be borne in mind that, for both a thermoset and a thermoplastic material, it is envisaged that each main manifold or distribution groove could be completely filled with seal material. In use, to effect a repair, it can then simply be removed mechanically, e.g. by drilling, or melting of a thermoplastic material. Further, it is contemplated that, in some cases, it may be necessary to form at least part of the bore, e.g. by drilling again, through one or more of the elements formed in the stack. For example, the original assembly method has been described with the seal material being injected from the side. For this purpose, it is not necessary to have a bore that opens out onto an end face of the cell assembly. Accordingly, this opening on an end face can be omitted. In use, for repair purposes, it could then be possible to simply drill a hole through and into the stack assembly to the necessary depth, so as to provide a bore for injection of fresh seal material. For this purpose, an end plate could be provided with an indication, e.g. an indentation, aligned with appropriate openings in the individual plates, so that a hole can readily be drilled, accurately to remove just existing seal material and form the necessary bore. In general, this operation would be performed before separation of the stack.

It is also possible that a bore could be formed at a location within a wholly new location within the cell stack, and such a bore need not necessarily be a cylindrical bore extending perpendicularly to the plates. At a minimum, it is simply necessary that any bore not intersect any chamber or conduit for fluids for operation of the cell (since otherwise injection of the seal material will cause it to leak into such chambers or conduits) and that it intersect with grooves or groove networks sufficiently to enable the grooves needing fresh seal material to be resealed.

For example, particularly for a large stack, it can be preferable to form an access bore from a side of the stack, which then avoids interfering in any way with the seals and other elements above and below plates etc. being repaired. This may be difficult with the thin plates found in many stacks, and it is possible that a bore could be formed in two or more adjacent plates, in the plane of the plates, to provide access to the required grooves.

The present invention also encompasses the possibility that not all the seal material within a cell assembly be homogenous. It is possible that different types of seal material could be used within one cell assembly. For example, the use of thermoplastic materials with different melting points would give additional flexibility and enable some seals to be melted and remove without affecting others. For example, between predetermined groups of cells, one could have a first groove network filled with a first thermoplastic of low melting point and then have a second groove network filled with a second thermoplastic having a higher melting point filling the grooves between individual cells of each group. This would enable the groups of cells to be separated from one another by raising the temperature of the whole stack to the first melting point without disturbing the seals within each cell group. Further, it is conceivable that mixed seal material could encompass the use of both thermoset and thermoplastic materials within one cell assembly, each supplied through a respective groove network.

Further, the invention has applicability for electrochemical assemblies with a variety of different original seals. For example, wherever permanent seals have been formed, e.g. by use of adhesives or the like, the present invention enables replacement seals to be formed by injecting a curable seal material.

1. An electrochemical cell assembly comprising:
(a) a plurality of separate elements, at least some of the elements including grooves for seals;
(b) a plurality of seals in the grooves between the plurality of separate elements, sealing the elements to control fluid flow;
wherein the elements and the seals are bonded together such that separation of two for more elements will result in damage to one or more of the seals and separate elements; and
wherein the electrochemical cell assembly includes, for each of at least some of the separate elements, a resealing portion permitting a bore to be formed therethrough to provide fluid communication to at least one of the grooves, whereby, in use, the electrochemical cell assembly can be at least partially disassembled, any damaged elements can be replaced, at least one bore can be formed through selected ones of said resealing portions connecting with said at least one of the grooves to form a groove network, whereby the electrochemical cell assembly can be reassembled and curable seal material can be injected into the groove network and cured to reseal the electrochemical cell assembly.

2. An electrochemical cell assembly as claimed in claim 1, wherein said plurality of separate elements include a plurality of separate plates arranged generally parallel to one another, and wherein the resealing portions are such as to enable at least one bore to be formed extending substantially perpendicularly to the separate elements.

3. An electrochemical cell assembly as claimed in claim 1, wherein the plurality of separate elements comprise a plurality of plates having edge surfaces and arranged substantially parallel to one another in a stack, the stack having side faces formed from the edge surfaces of the plurality of separate elements, and wherein the resealing portions enable bores to be formed extending from the side surfaces of the stack into the stack to communicate with at least one of said grooves.

4. An electrochemical cell assembly as claimed in claim 2 or 3 wherein each resealing portion includes an aperture in which said at least one bore can be formed.

5. An electrochemical cell assembly as claimed in claim 4, wherein in an originally assembled condition of the electrochemical cell assembly, said at least one bore is empty.

6. An electrochemical cell as claimed in claim 4, wherein, in an originally assembled condition of the electrochemical cell assembly, said at least one bore is filled with a sealant material.

7. An electrochemical cell assembly as claimed in claim 2 or 3, wherein said resealing portions comprise solid portions of the separate elements, sufficiently spaced from any active areas and apertures of the separate elements, to permit a bore to be formed in use to provide access to said at least one groove.

8. An electrochemical cell assembly as claimed in claim 7, wherein each of the separate elements comprises an active area, and a plurality of apertures adjacent to the active area and adapted to align with apertures of other elements to form manifolds for fluids extending through the stack , and wherein the resealing portions are provided between the apertures and the active areas and sufficiently spaced therefrom to permit said at least one bore to be formed in use.

9. An electrochemical cell assembly as claimed in claim 1, wherein the resealing portions comprise apertures for a sealant aligned to form at least one groove manifold for the sealant extending through the plurality of separate elements, and wherein each said at least one bore comprises a bore extending within each groove manifold and spaced from sides thereof.

10. An electrochemical cell assembly as claimed in claim 9, wherein each bore and each groove manifold are generally cylindrical.

11. An electrochemical cell assembly as claimed in claim 9, wherein the plurality of separate elements includes a plurality of anode and cathode plates stacked parallel to one another, and wherein each groove manifold and each bore extend substantially perpendicular to the anode and cathode plates.

12. An electrochemical cell assembly as claimed in claim 1, wherein the sealant material comprises a thermoset material.

13. An electrochemical cell assembly as claimed in claim 12, wherein the thermoset material comprises a silicone-based material.

14. An electrochemical cell assembly as claimed in claim 1, wherein the sealant material comprises a thermoplastic.

15. An electrochemical cell assembly as claimed in claim 9 which includes a transverse duct extending through at least one element of the electrochemical cell assembly to the groove manifold, for supply of the seal material during original assembly of the electrochemical cell assembly.

16. An electrochemical cell assembly as claimed in claim in claim 9, wherein the groove manifold is open at both ends, to enable a rod to be inserted and located within the main manifold during assembly, to form each bore.

17. An electrochemical cell assembly comprising:
a plurality of separate elements;
at least one groove network extending through the electrochemical cell assembly and at least partially between the plurality of separate elements, and including at least one filling port for the at least one groove network;
a seal within the at least one groove network, that seal having been formed in place from a cured liquid seal material after assembly of said separate elements, wherein the seal provides a barrier between at least two of said separate elements to define a chamber for a fluid for operation of the electrochemical cell assembly; and
for each of at least some of the plurality of separate elements of the electrochemical cell assembly, a resealing portion permitting at least one bore to be formed therethrough to provide fluid communication to at least one of the groove networks, whereby in use, the electrochemical cell assembly can be at least partially disassembled, and subsequently reassembled, with said at least one bore enabling a liquid seal material to be injected after reassembly for resealing the electrochemical cell assembly.

18. An electrochemical cell assembly as claimed in claim 17, wherein the resealing portion comprise for each of at least some of the elements, an aperture aligned to form at least one groove manifold extending through the electrochemical cell assembly.

19. An electrochemical cell assembly as claimed in claim 18, wherein the plurality of separate elements includes a plurality of anode and cathode plates stacked parallel to one another, and wherein the manifold extends substantially perpendicularly to the anode and cathode plates.

20. An electrochemical cell assembly as claimed in claim 19, including a transverse duct extending through one element of the electrochemical cell assembly to at least one groove manifold, for supply of liquid seal material during original assembly of the electrochemical cell assembly.

21. An electrochemical cell assembly as claimed in any one of claims 20, wherein each at least one groove manifold is open at both ends, to enable a bore to be formed extending through the entire electrochemical cell assembly.

22. An electrochemical cell assembly as claimed in claim 17, wherein said plurality of separate elements include a plurality of separate plates arranged generally parallel to one another, and wherein the resealing portions are such as to enable at least one bore to be formed extending substantially perpendicularly to the separate elements.

23. An electrochemical cell assembly as claimed in claim 17, wherein the plurality of separate elements comprise a plurality of plates having edge surfaces and arranged substantially parallel to one another in a stack, the stack having ends and side faces formed from the edge surfaces of the plurality of separate elements, and wherein the resealing portions enable bores to be formed extending from the side surfaces of the stack into the stack to communicate with at least one of said grooves.

24. A method of forming a seal in an electrochemical cell assembly comprising a plurality of separate elements, the method comprising:
(a) assembling the separate elements of the fuel cell together;
(b) providing at least one groove network extending through the separate elements and a filling port open to the exterior and in communication with the at least one groove network;
(c) connecting a source of liquid seal material to the filling port and injecting the seal material into the at least one groove network to fill the at least one groove network and simultaneously venting gas therefrom; and
(d) forming a bore in the seal material extending through at least some of the plurality of separate elements, and curing the seal material, to form a seal in the at least one groove network.

25. A method as claimed in claim 24, wherein step (d) includes inserting a rod extending through apertures in said at least some of the plurality of separate elements, to form the bore.

26. A method as claimed in claim 25, the method including providing said at least some of the plurality of separate elements with apertures, aligning the apertures to form a main groove manifold extending through the electrochemical cell assembly and providing the rod within the main groove manifold and spaced from sides thereof.

27. A method as claimed in claim 25 or 26, the method comprising providing the rod within the electrochemical cell assembly prior to injection of the seal material into the groove network and removing the rod after the seal material has cured and set.

28. A method as claimed in claim 25 or 26, the method comprising, after injecting the seal material to fill the groove network, inserting the rod to displace excess seal material, and subsequently curing the seal material.

29. A method as claimed in any of claim 24, 25 or 26, including providing a thermoset material as the seal material and, in step (d), heating the electrochemical cell assembly and the seal material to cure the seal material.

30. A method as claimed in claim 24, 25 or 26, including providing a thermoplastic as the seal material and, in step (d), cooling the electrochemical cell and the seal material to cure the seal material to cause the seal material to set.

31. A method of forming a seal in an electrochemical cell assembly comprising a plurality of separate elements, the method comprising:
(a) assembling the separate elements of the fuel cell together;
(b) providing at least one main manifold extending through the plurality of separate elements and including at least one open end open to the exterior of the electrochemical cell assembly;
(c) providing at least one groove network extending through the separate elements and a filling port open to the exterior and in communication with the at least one main manifold and with the at least one groove network;
(d) connecting a source of liquid seal material to the filling port and injecting the seal material into the at least one groove network to fill the at least one groove network and simultaneously venting gas therefrom;
whereby, the provision of said at least one open end enables a bore to be formed subsequently through at least some elements of the electrochemical cell assembly, for reassembly thereof.

32. A method as claimed in claim 31, the method including providing said at least some of the plurality of separate elements with generally circular apertures, aligning the apertures to form a main groove manifold extending through the electrochemical cell and forming said at least one open end.

33. A method of disassembling and reassembling an electrochemical cell assembly comprising:
(a) a plurality of separate elements, at least some of the separate elements including grooves for seals;
(b) a plurality of seals in the grooves between the separate elements; the method comprising the steps of:
(1) separating the electrochemical cell assembly into at least two parts, each including at least one of said plurality of separate elements;
(2) cleaning and removing any existing seal material in one or more of the grooves on facing surfaces of said at least two parts of the electrochemical cell assembly;
(3) providing at least one bore extending through the electrochemical cell assembly, and communicating with each empty groove;
(4) reassembling the said at least two parts together; and
(5) injecting fresh seal material through the bore to fill each empty groove, and curing the fresh seal material to reform the seal between said at least two parts of the electrochemical cell assembly.

34. A method as claimed in claim 33, the method including providing in the original electrochemical cell assembly, said bore as at least one bore extending through at least some of the elements of the electrochemical cell assembly.

35. A method as claimed in claim 34, the method additionally including in step (4), providing a rod extending through the electrochemical cell assembly, prior to causing the seal material to set, to reform the bore in the electrochemical cell assembly.

36. A method as claimed in claim 33, wherein step (3) comprises forming the bore by removing portions of the separate elements to form seal apertures, the seal apertures being aligned to form a groove manifold.

37. A method as claimed in any one of claims 33 the method being applied to an electrochemical cell stack assembly including a plurality of alternating anode and cathode plates and a plurality of membrane electrode assemblies sandwiched between the anode and cathode plates, the method further comprising:
(a) separating the electrochemical cell assembly at least two locations including one of the plurality of membrane electrode assemblies;
(b) for the plates and membrane exchange assemblies between said two locations, effecting one of: separating individual plates, cleaning the individual plates of seal material for reuse, and providing replacement membrane exchange assemblies where required; and discarding all the anode plates, cathode plates and the membrane exchange assemblies located between said two locations and providing replacement, clean anode plates, cathode plates and membrane exchange assemblies;
(c) reassembling the electrochemical cell assembly; and
(d) injecting fresh seal material to fill the empty grooves and causing the seal material to set.

38. A method as claimed in claim 37, the method comprising providing the original electrochemical cell assembly with at least one main groove manifold at least partially filled with seal material, the method further comprising removing the seal material from said at least one main manifold to form said at least one bore.

39. A method as claimed in claim 38, including providing, at least within each main groove manifold, a thermoplastic seal material, and the method further comprising forming the bore by melting the thermoplastic seal material to permit removal thereof.

40. A method as claimed in claim 38, further comprising mechanically removing the seal material from each main groove manifold, to form the bore.

41. A method as claimed in claim 37, the method further comprising mechanically removing at least part of one of the elements to form the bore for supply of the seal material.

42. An apparatus for providing a seal material to an electrochemical cell assembly for sealing various components of the electrochemical cell, the apparatus comprising:
(a) a main body;
(b) an inlet disposed near one end of the main body for receiving the seal material; and
(c) an outlet disposed near the other end of the main body for providing the seal material to at least one portion of the electrochemical cell;
wherein the main body generally has an appropriate shape for leaving a bore in the electrochemical cell after the seal material has been delivered to the electrochemical cell.

43. The apparatus of claim 42, wherein the main body includes an inner member and an outer member, the inner member including a slot for providing the seal material to the outer member and the outer member having a plurality of apertures vertically displaced from one another for providing the seal material to various portions of the electrochemical cell assembly.

44. The apparatus of claim 43, wherein the slot on the inner member is substantially vertical and the apertures on the outer member are horizontally displaced from one another and the apparatus further includes a rotation means for rotating the members with respect to one another so that the apertures provide the seal material to the various portions of the electrochemical cell assembly in a sequential manner.

45. The apparatus of claim 43, wherein the slot on the inner member is displaced at an angle, the apertures on the outer member are substantially vertical and the apparatus further includes a rotation means for rotating the members with respect to one another so that the apertures provide the seal material to the various portions of the electrochemical cell assembly in a sequential manner.

46. The apparatus of claim 43, wherein the apparatus further includes a rotation means for rotating the members with respect to one another and the slot on the inner member and the apertures on the outer member, when aligned, are disposed such that at most only one of the apertures is aligned with the slot when the members are rotating so that seal material flows through the apertures one at a time.
